(19) United States
(12) Patent Application Publication
(10) Pub. No.: US 2025/0272127 A1
(43) Pub. Date: Aug. 28, 2025

(54) CONSOLIDATION OF INTERPRETER INSTRUCTIONS

(71) Applicant: SAP SE, Walldorf (DE)

(72) Inventors: Lukas Rapp, Heidelberg (DE); Marc Auberer, Heidelberg (DE); Markus Eble, Walldorf (DE)

(73) Assignee: SAP SE, Walldorf (DE)

(21) Appl. No.: 18/590,647

(22) Filed: Feb. 28, 2024

(51) Int. Cl. G06F 9/455

(52) U.S. Cl. CPC G06F 9/45508

(57) ABSTRACT

In some scenarios, computers execute compiled executables, while in others interpreter instructions are processed. In some scenarios, such as query execution in a relational database, if a compiled executable does not exist for a query, execution of the query can begin with an interpreter while a compiled executable is generated. The present disclosure provides for improved interpreter execution by consolidating multiple interpreter instructions in a consolidated interpreter instruction. In some cases, machine code corresponding to an interpreter instruction can be included in the consolidated instruction instead of the interpreter instruction. For interpreter instructions where a machine code replacement is not defined, the instruction, such as a function call, can be devirtualized. Using one or more of these techniques can result in faster execution of the interpreter and reduce computing resource use.

### FIELD

The present disclosure generally relates to program execution using an interpreter. Particular implementations relate to consolidating interpreter instructions, such as instructions associated with a program to execute a query.

### BACKGROUND

While databases have been around for decades, their use continues to increase. The transition from analog world activities to a digital environment continues, and database technologies underlie a huge amount of software that facilitates these transactions. Thus, it is desirable to continue to improve database performance.

One aspect of database performance involves how quickly query execution can begin once a query is received. Databases typically operate by using an interpreter to execute query instructions, or compiling query instructions to an executable, or both. As examples where both techniques can be used, certain types of queries can be more efficiently executed by an interpreter and some queries executed more efficiently using compiled code, and a database can select a particular execution technique based on the nature of a given query.

Among various differences in executing query instructions with an interpreter or executing compiled code, the techniques differ in how quickly execution can begin and how quickly execution occurs. Generally, compiling a query plan to an executable code is more time consuming than preparing the interpreter for execution. However, execution of compiled code is typically faster than interpreter execution once the compilation result is available. That is, query execution can begin more quickly using an interpreter, but the actual execution is often slower than execution of the compilation result.

In some databases, the two techniques can be leveraged to provide improved query performance. That is, when a query is received, if compiled code is not available for execution, the database can start compiling an executable that can be used to execute the query. However, the database also begins query execution using the interpreter. Once compilation is complete, the database can cease executing the query using the interpreter and switch to the compiled executable. However, in this scenario, and in situations where query execution is entirely handled by interpretation, the execution speed of the interpreter affects how quickly query results are provided. Accordingly, room for improvement exists.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In some scenarios, computers execute compiled executables, while in others interpreter instructions are processed. In some scenarios, such as query execution in a relational database, if a compiled executable does not exist for a query, execution of the query can begin with an interpreter while a compiled executable is generated. The present disclosure provides for improved interpreter execution by consolidating multiple interpreter instructions in a consolidated interpreter instruction. In some cases, machine code corresponding to an interpreter instruction can be included in the consolidated instruction instead of the interpreter instruction. For interpreter instructions where a machine code replacement is not defined, the instruction, such as a function call, can be devirtualized. Using one or more of these techniques can result in faster execution of the interpreter and reduce computing resource use.

In one aspect, the present disclosure provides a process for consolidating interpreter instructions. The process can allow for interpreter instructions to be executed more quickly and efficiently. A set of a plurality of interpreter instructions is received. For respective interpreter instructions of the set of interpreter instructions, it is determined at whether an operation is defined to replace the respective interpreter instruction with assembly code, where operations are defined for less than all types of interpreter instructions. For respective interpreter instructions where an operation is defined, the assembly code for a respective interpreter instruction is included in a consolidated interpreter instruction. The consolidated interpreter instruction is executed, where the consolidated interpreter instruction replaces multiple interpreter instructions of the set of the plurality of interpreter instructions with corresponding assembly code.

The present disclosure also includes computing systems and tangible, non-transitory computer readable storage media configured to carry out, or including instructions for carrying out, an above-described method. As described herein, a variety of other features and advantages can be incorporated into the technologies as desired.

### BRIEF DESCRIPTION OF THE DRAWINGS

FIG. 1 is a diagram depicting an example database system which can be used in implementing aspects of disclosed technologies.

FIG. 2 illustrates a query, an abstract syntax tree representation of the query, a logical plan for the query, a physical plan for the query, and a program useable to execute operations to perform the query.

FIG. 3 illustrates example interpreter instruction for the program of FIG. 2, as well as example pseudo-assembly code for implementing an addition operation performed during query execution.

FIG. 4 illustrates example interpreter instructions and how they can be executed by an interpreter loop, and ways of consolidating interpreter instructions according to disclosed techniques.

FIG. 5 illustrates an example array of Node Value object instances, which include information about nodes/operations for a set of interpreter operations.

FIG. 6 is a diagram illustrating how multiple interpreter operations can be consolidated into a single instruction, including by replacing an instruction with assembly code that corresponds to the operation.

FIG. 7 is a diagram illustrating how multiple interpreter operations can be consolidated into a single instruction, including using register allocation.

FIG. 8 is a diagram illustrating example classes that can be used in generating assembly code for particular types of interpreter instructions.

FIG. 9 is an example class definition for generating assembly code for an XOR operation.

FIG. 10 illustrates example instructions having different numbers of operands, as well as an example of an invalid instruction.

FIG. 11 is an example code listing of a function to write machine code for a subtraction operation.

FIG. 12 illustrates a technique to identify machine code used to implement instructions, including a dump of machine code and assembly code generated from disassembly of the machine code.

FIGS. 13 and 14 illustrate a technique for determining a memory block size for a set of instructions.

FIG. 15 presents an example algorithm for executing a consolidated instruction generated using disclosed techniques.

FIG. 16 presents an example algorithm for generating code snippets, including determining whether a node/instruction is translatable and can be included in a current code snippet.

FIG. 17 presents an example algorithm for writing buffered nodes/instructions to a code snippet.

FIG. 18 presents an example algorithm for determining whether an instruction can be translated to assembly code or should be devirtualized.

FIGS. 19 and 20 present, respectively example code initiating and execute execution of a code snippet.

FIG. 21 presents an example algorithm for selecting an instance of a Node Value object given an index into a array of Node Value instances.

FIG. 22 is a diagram illustrating how node values can be obtained by dereferencing a point to a Node Value array and then a pointer value of a particular array element.

FIG. 23 presents an example algorithm for dereferences Node Value pointers.

FIG. 24 presents an example algorithm for loading a NodeValue instance into a register.

FIG. 25 presents an example algorithm for storing an intermediate result in a NodeValue instance.

FIG. 26 illustrates assembly instructions that can be generated for operations in a program using disclosed techniques.

FIG. 27 is a diagram illustrating how member selections can be implemented through direct access or indirect access.

FIG. 28 is a diagram illustrating direct member selection from a NodeValue instance and a corresponding ValueObject structure.

FIG. 29 is a code listing of a function for extracting a function pointer from a VTable for use in function devirtualization.

FIG. 30 is a diagram illustrating extraction of a function pointer from a VTable for use in function devirtualization.

FIG. 31 illustrates example code for preparing arguments for a devirtualized function call, for invoking a devirtualized function call, for checking for execution exceptions during devirtualized function call execution, and for returning from devirtualized function call execution when an exception is encountered.

FIG. 32 illustrates an example program and example interpreter instructions for executing the program.

FIGS. 33A and 33B illustrate a consolidated instruction/code snippet, that can be generated from the program and interpreter instructions of FIG. 32.

FIG. 34 is a flowchart of a process for consolidating interpreter instructions.

FIG. 35 is a diagram of an example computing system in which some described embodiments can be implemented.

FIG. 36 is an example cloud computing environment that can be used in conjunction with the technologies described herein.

### DETAILED DESCRIPTION

### Example 1—Overview

While databases have been around for decades, their use continues to increase. The transition from analog world activities to a digital environment continues, and database technologies underlie a huge amount of software that facilitates these transactions. Thus, it is desirable to continue to improve database performance.

One aspect of database performance involves how quickly query execution can begin once a query is received. Databases typically operate by using an interpreter to execute query instructions, or compiling query instructions to an executable, or both. As examples where both techniques can be used, certain types of queries can be more efficiently executed by an interpreter and some queries executed more efficiently using compiled code, and a database can select a particular execution technique based on the nature of a given query.

Among various differences in executing query instructions with an interpreter or executing compiled code, the techniques differ in how quickly execution can begin and how quickly execution occurs. Generally, compiling a query plan to an executable is more time consuming than preparing the interpreter for execution. However, execution of compiled code is typically faster than interpreter execution once the compilation result is available. That is, query execution can begin more quickly using an interpreter, but the actual execution is often slower than execution of the compilation result.

In some databases, the two techniques can be leveraged to provide improved query performance. That is, when a query is received, if compiled code is not available for execution, the database can start compiling the code to a compiled executable that can then be executed to perform the query. However, the database also begins query execution using the interpreter. Once compilation is complete, the database can cease executing the query using the interpreter and switch to the compiled executable. However, in this scenario, and in situations where query execution is entirely handled by interpretation, the execution speed of the interpreter affects how quickly query results are provided. Accordingly, room for improvement exists.

The present disclosure provides techniques for increasing the speed of an interpreter, such as an interpreter used for executing database operations. When used with a database, the interpreter can be the primary execution engine, or the interpreter can be used for query execution until compiled code is available.

As will be explained in greater detail, a query can go through a variety of processing stages and have a variety of representations. For example, a query in a query language, such as SQL, can be converted to an abstract syntax tree that facilitate processing of the query by a computer, including in optimizing a logical query execution plan for the query. The optimized logical query execution plan can then be converted to a physical plan, where operations are tied more specifically to a particular computing environment in which the query will be executed. A computer program, such as in a language like C++, can be generated, and used for query execution, such as by compiling the program to an executable or generating interpreter instructions that are then executed by an interpreter.

Typically, and at a fairly high level of abstraction, the interpreter operates in a loop, where a next instruction is selected for execution and an instruction execution routine is called. The calling and executing of the instruction execution routine incurs overhead, slowing the performance of the interpreter.

Virtual function calls can also slow the performance of the interpreter. For example, in some implementations, the execution loop for an interpreter calls a generic execute function. That execute function is then resolved to the particular execute function for a particular instruction being processed. That is, the interpreter is aware of the appropriate runtime object, and can resolve the function call to a specific derived class (type of instruction), which involves a lookup to a “Vtable.” The Vtable has a pointer to the correction function implementation (such as in the form of a memory address). The table lookup and the indirection resulting from use of the pointer both introduce delay.

The present disclosure provides for improved interpreter performance by consolidating multiple interpreter instructions into a single interpreter instruction. For example, a lightweight assembler can be associated with an interpreter. The lightweight assembler produces machine code for common/simple interpreter instructions, such as arithmetic operations. The translated code is then used in the consolidated instruction.

In another aspect, rather than performing virtual function during instruction execution, the function calls are devirtualized in a preprocessing step prior to operation execution, in which the function address is read from the Vtable. The devirtualized function call is then part of a set of consolidated interpreter instructions that are translated to one machine code unit.

Thus, disclosed techniques can improve execution performance in a number of ways. By consolidating instructions, fewer execution operations need to be performed. The devirtualization technique allows a greater variety of instructions to be consolidated.

### Example 2—Example Database Architecture

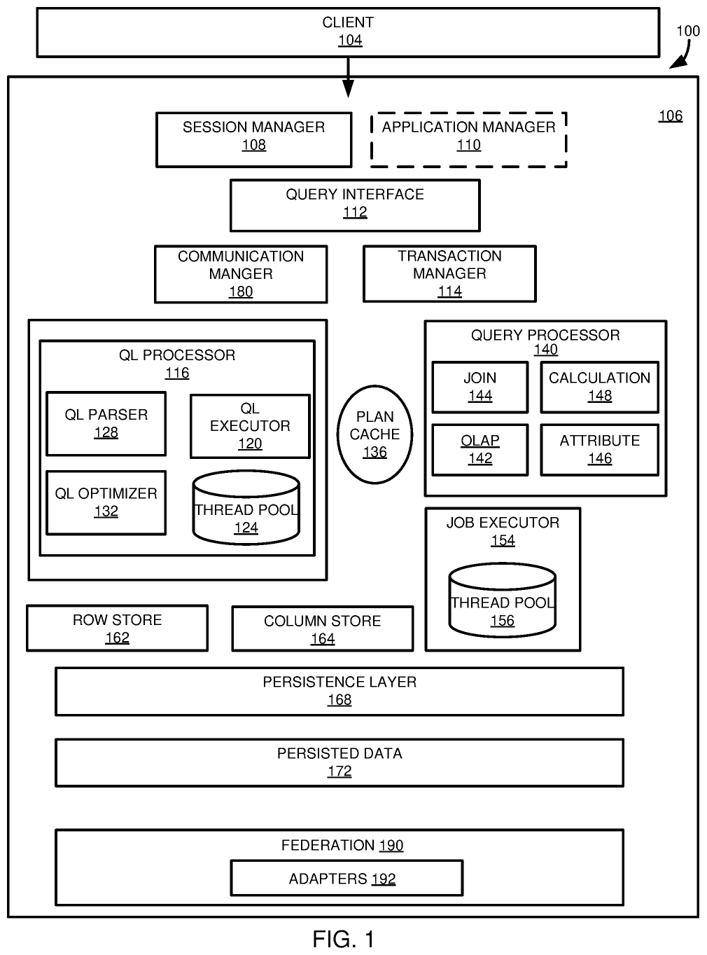

FIG. 1 illustrates an example database environment 100. The database environment 100 can include a client 104. Although a single client 104 is shown, the client 104 can represent multiple clients. The client or clients 104 may be OLAP clients, OLTP clients, or a combination thereof.

The client 104 is in communication with a database server 106. Through various subcomponents, the database server 106 can process requests for database operations, such as requests to store, read, or manipulate data (i.e., CRUD operations). A session manager component 108 can be responsible for managing connections between the client 104 and the database server 106, such as clients communicating with the database server using a database programming interface, such as Java Database Connectivity (JDBC), Open Database Connectivity (ODBC), or Database Shared Library (DBSL). Typically, the session manager 108 can simultaneously manage connections with multiple clients 104. The session manager 108 can carry out functions such as creating a new session for a client request, assigning a client request to an existing session, and authenticating access to the database server 106. For each session, the session manager 108 can maintain a context that stores a set of parameters related to the session, such as settings related to committing database transactions or the transaction isolation level (such as statement level isolation or transaction level isolation).

For other types of clients 104, such as web-based clients (such as a client using the HTTP protocol or a similar transport protocol), the client can interface with an application manager component 110. Although shown as a component of the database server 106, in other implementations, the application manager 110 can be located outside of, but in communication with, the database server 106. The application manager 110 can initiate new database sessions with the database server 106, and carry out other functions, in a similar manner to the session manager 108.

The application manager 110 can determine the type of application making a request for a database operation and mediate execution of the request at the database server 106, such as by invoking or executing procedure calls, generating query language statements, or converting data between formats useable by the client 104 and the database server 106. In particular examples, the application manager 110 receives requests for database operations from a client 104, but does not store information, such as state information, related to the requests.

Once a connection is established between the client 104 and the database server 106, including when established through the application manager 110, execution of client requests is usually carried out using a query language, such as the structured query language (SQL). In executing the request, the session manager 108 and application manager 110 may communicate with a query interface 112. The query interface 112 can be responsible for creating connections with appropriate execution components of the database server 106. The query interface 112 can also be responsible for determining whether a request is associated with a previously cached statement or a stored procedure, and calling the stored procedure or associating the previously cached statement with the request.

At least certain types of requests for database operations, such as statements in a query language to write data or manipulate data, can be associated with a transaction context. In at least some implementations, each new session can be assigned to a transaction. Transactions can be managed by a transaction manager component 114. The transaction manager component 114 can be responsible for operations such as coordinating transactions, managing transaction isolation, tracking running and closed transactions, and managing the commit or rollback of transactions. In carrying out these operations, the transaction manager 114 can communicate with other components of the database server 106.

The query interface 112 can communicate with a query language processor 116, such as a structured query language processor. For example, the query interface 112 may forward to the query language processor 116 query language statements or other database operation requests from the client 104. The query language processor 116 can include a query language executor 120, such as a SQL executor, which can include a thread pool 124. Some requests for database operations, or components thereof, can be executed directly by the query language processor 116. Other requests, or components thereof, can be forwarded by the query language processor 116 to another component of the database server 106. For example, transaction control statements (such as commit or rollback operations) can be forwarded by the query language processor 116 to the transaction manager 114. In at least some cases, the query language processor 116 is responsible for carrying out operations that retrieve or manipulate data (e.g., SELECT, UPDATE, DELETE). Other types of operations, such as queries, can be sent by the query language processor 116 to other components of the database server 106. The query interface 112, and the session manager 108, can maintain and manage context information associated with requests for database operation. In particular implementations, the query interface 112 can maintain and manage context information for requests received through the application manager 110.

When a connection is established between the client 104 and the database server 106 by the session manager 108 or the application manager 110, a client request, such as a query, can be assigned to a thread of the thread pool 124, such as using the query interface 112. In at least one implementation, a thread is associated with a context for executing a processing activity. The thread can be managed by an operating system of the database server 106, or by, or in combination with, another component of the database server. Typically, at any point, the thread pool 124 contains a plurality of threads. In at least some cases, the number of threads in the thread pool 124 can be dynamically adjusted, such in response to a level of activity at the database server 106. Each thread of the thread pool 124, in particular aspects, can be assigned to a plurality of different sessions.

When a query is received, the session manager 108 or the application manager 110 can determine whether an execution plan for the query already exists, such as in a plan cache 136. If a query execution plan exists, the cached execution plan can be retrieved and forwarded to the query language executor 120, such as using the query interface 112. For example, the query can be sent to an execution thread of the thread pool 124 determined by the session manager 108 or the application manager 110. In a particular example, the query plan is implemented as an abstract data type.

If the query is not associated with an existing execution plan, the query can be parsed using a query language parser 128. The query language parser 128 can, for example, check query language statements of the query to make sure they have correct syntax, and confirm that the statements are otherwise valid. For example, the query language parser 128 can check to see if tables and records recited in the query language statements are defined in the database server 106.

The query can also be optimized using a query language optimizer 132. The query language optimizer 132 can manipulate elements of the query language statement to allow the query to be processed more efficiently. For example, the query language optimizer 132 may perform operations such as unnesting queries or determining an optimized execution order for various operations in the query, such as operations within a statement. After optimization, an execution plan can be generated, or compiled, for the query. In at least some cases, the execution plan can be cached, such as in the plan cache 136, which can be retrieved (such as by the session manager 108 or the application manager 110) if the query is received again.

The query optimizer 132 can also implement techniques of the present disclosure. For example, the query optimizer 132 can communicate with an auxiliary query optimization framework. The auxiliary query optimization framework can be part of the database server 106, or the database server can communicate with an auxiliary query optimization framework that is remote to the database server. The query optimizer 132, as part of the query language processor 116—which includes components like the parser 128 and the query language executor 120—can also facilitate the conversion between different query and query plan formats. For instance, it might convert between a representation of a query or a logical query plan and an abstract query plan. This conversion can involve generating one representation from another, and might entail adding or removing specific information to or from a given representation.

Once a query execution plan has been generated or received, the query language executor 120 can oversee the execution of an execution plan for the query. For example, the query language executor 120 can invoke appropriate subcomponents of the database server 106. The query language executor 120 can include functionality to compile a physical query plan to an executable or generate interpreter instructions. The query language executor 120 can also include functionality to monitor the compilation process, and switch from interpreter execution to execution of the compiled code once compilation is complete.

In executing the query, the query language executor 120 can call a query processor 140, which can include one or more query processing engines. The query processing engines can include, for example, an OLAP engine 142, a join engine 144, an attribute engine 146, or a calculation engine 148. The OLAP engine 142 can, for example, apply rules to create an optimized execution plan for an OLAP query. The join engine 144 can be used to implement relational operators, typically for non-OLAP queries, such as join and aggregation operations. In a particular implementation, the attribute engine 146 can implement column data structures and access operations. For example, the attribute engine 146 can implement merge functions and query processing functions, such as scanning columns.

In certain situations, such as if the query involves complex or internally parallelized operations or sub-operations, the query executor 120 can send operations or sub-operations of the query to a job executor component 154, which can include a thread pool 156. An execution plan for the query can include a plurality of plan operators. Each job execution thread of the job execution thread pool 156, in a particular implementation, can be assigned to an individual plan operator. The job executor component 154 can be used to execute at least a portion of the operators of the query in parallel. In some cases, plan operators can be further divided and parallelized, such as having operations concurrently access different parts of the same table. Using the job executor component 154 can increase the load on one or more processing units of the database server 106, but can improve execution time of the query.

The query processing engines of the query processor 140 can access data stored in the database server 106. Data can be stored in a row-wise format in a row store 162, or in a column-wise format in a column store 164. In at least some cases, data can be transformed between a row-wise format and a column-wise format. A particular operation carried out by the query processor 140 may access or manipulate data in the row store 162, the column store 164, or, at least for certain types of operations (such a join, merge, and subquery), both the row store 162 and the column store 164. In at least some aspects, the row store 162 and the column store 164 can be maintained in main memory.

A persistence layer 168 can be in communication with the row store 162 and the column store 164. The persistence layer 168 can be responsible for actions such as committing write transactions, storing redo log entries, rolling back transactions, and periodically writing data to storage to provided persisted data 172.

In executing a request for a database operation, such as a query or a transaction, the database server 106 may need to access information stored at another location, such as another database server. The database server 106 may include a communication manager 180 component to manage such communications. The communication manger 180 can also mediate communications between the database server 106 and the client 104 or the application manager 110, when the application manager is located outside of the database server.

In some cases, the database server 106 can be part of a distributed database system that includes multiple database servers. At least a portion of the database servers may include some or all of the components of the database server 106. The database servers of the database system can, in some cases, store multiple copies of data. For example, a table may be replicated at more than one database server. In addition, or alternatively, information in the database system can be distributed between multiple servers. For example, a first database server may hold a copy of a first table and a second database server can hold a copy of a second table. In yet further implementations, information can be partitioned between database servers. For example, a first database server may hold a first portion of a first table and a second database server may hold a second portion of the first table.

In carrying out requests for database operations, the database server 106 may need to access other database servers, or other information sources, within the database system, or at external systems, such as an external system on which a remote data object is located. The communication manager 180 can be used to mediate such communications. For example, the communication manager 180 can receive and route requests for information from components of the database server 106 (or from another database server) and receive and route replies.

The database server 106 can include components to coordinate data processing operations that involve remote data sources. In particular, the database server 106 includes a data federation component 190 that at least in part processes requests to access data maintained at a remote system. In carrying out its functions, the data federation component 190 can include one or more adapters 192, where an adapter can include logic, settings, or connection information usable in communicating with remote systems. Examples of adapters include “connectors” as implemented in technologies available from SAP SE, of Walldorf, Germany. Further, disclosed techniques can use technologies underlying data federation techniques such as Smart Data Access (SDA) and Smart Data Integration (SDI) of SAP SE.

### Example 3—Example Query Representations

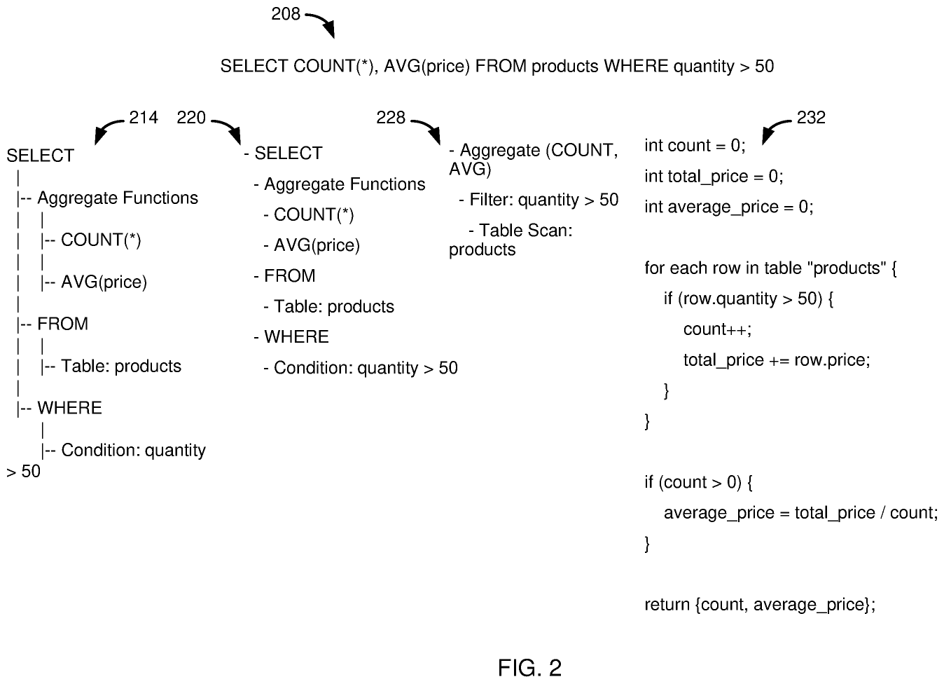

FIG. 2 presents a simplified example of how a query 208 can be processed to an executable form. The query 208 specifies operations for searching a products table for products having a value greater than 50 for a quantity attribute. For those products, the query 208 calculates the number of products satisfying the criterion and the average price of those products.

When the query 208 is received, an abstract syntax tree 214 can be generated for the query, where abstract syntax tree represents the hierarchical structure of the query in a way that reflects the logical operations and relationships between elements. Query optimization results in a logical query plan 220, which is generated from the abstract syntax tree 214. Like the abstract syntax tree 214, the logical query plan 220 outlines the sequence of logical operations and their relationships within the query.

In this case the query 208 is relatively simple, and so the logical query plan 220 is very similar to the abstract syntax tree 214. In the case of more complex queries, the logical query plan might differ from the abstract syntax tree because it involves additional optimization steps, query rewrite transformations, and query execution planning, which may lead to a more optimized and efficient representation tailored for execution. For example, the query planner may rearrange join orders to minimize the number of row scans or push down filters to reduce the amount of data transferred between nodes in a distributed database system, resulting in differences between the logical plan and the initial abstract syntax tree.

A physical query plan 228 can be generated from the logical query plan 220. The physical query plan 228 represents a further refinement of the logical plan, specifying the specific operations and execution details needed to execute the query efficiently. These operations may include tasks such as filter operations, table scans, index scans, join strategies, and sort operations. Therefore, while the logical query plan 220 outlines the high-level logical operations and relationships, the physical query plan 228 delves into the implementation specifics, such as which indexes to use, how data will be accessed, and how data will be sorted. From the physical query plan 228, execution instructions are generated to carry out the query 208 efficiently on a specific database system. These instructions provide low-level details for database execution engines to follow, enabling them to retrieve and process data effectively.

As discussed above, depending on implementation, the instructions generated from the physical query plan 228 can be compiled to an executable and executed, converted to interpreter-executable instructions, or execution can begin with interpreter instructions and transition to compiled code once compilation is complete. The instructions can correspond to a computer program, such as the program 232, which is shown in a language similar to C or C++.

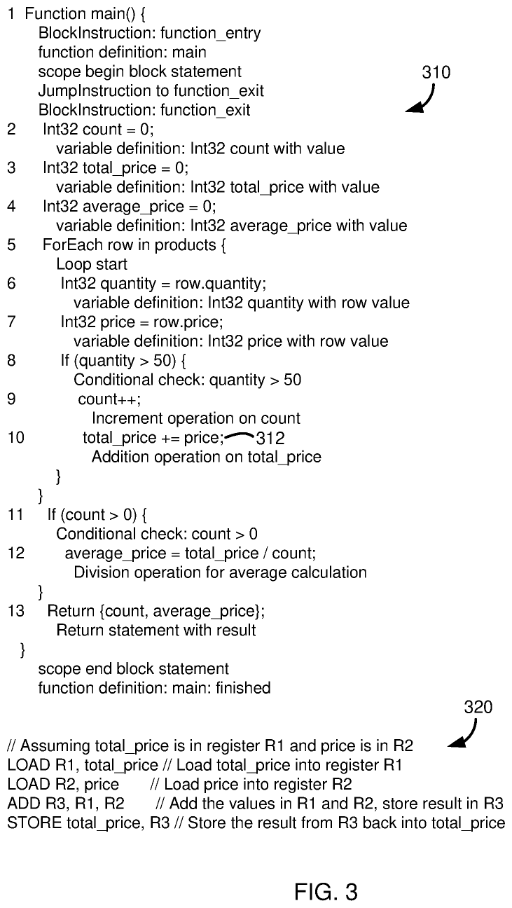

FIG. 3 illustrates interpreter instructions 310 that can be generated from the program 232 of FIG. 2. The interpreter instructions 310 represent a lower-level, platform-independent set of instructions that describe the logic of the query. These instructions are typically designed for ease of interpretation and portability across different platforms. Interpreter code focuses on providing step-by-step directions for executing each operation specified in the physical query plan, often resembling a high-level pseudocode or scripting language.

A distinction between the program 232 and the interpreter instructions 310 lies in their level of abstraction and execution approach. The program 232, written in a language such as C or C++, is a human-readable representation of the query execution logic. It may include high-level constructs, variable declarations, and algorithmic structures. Conversely, the interpreter instructions 310 are designed for efficient interpretation by the query execution engine. They are typically less verbose and lack some of the abstractions found in high-level programming languages.

While the program 232 provides a human-readable representation for query development and debugging, the interpreter instructions 310 are optimized for query execution speed and portability. Depending on the implementation, the interpreter instructions 310 may be executed directly by an interpreter or further compiled into machine code for faster execution, allowing the database system to strike a balance between flexibility and performance.

FIG. 3 also illustrates a human-readable representation (such as in assembly language) of machine code 320 (referred to hereinafter as machine code) for a portion of the interpreter instructions 310 (or, more generally, machine code that carries out operations in the physical query plan 228). The machine code 320 focuses on specific operations in calculating the average price. More specifically, the machine code 320 defines specific operations for calculating a total price, which can be divided by the count to provide the average price.

Compared with the interpreter instructions 310, the machine code 320 represents a much lower-level form of instructions, closer to the binary code that a computer's central processing unit (CPU) can directly execute. Each machine code instruction corresponds to a specific operation performed by the CPU, such as arithmetic calculations, memory access, or branching.

For example, the interpreter instructions 310 include an addition assignment operation 312 for calculating the total price. In the corresponding machine code 320, this operation 312 is broken down into a series of low-level instructions, such as loading values from memory, performing additions, and storing results. The machine code 320 provides precise, granular control over hardware resources and execution flow, optimizing performance but sacrificing human readability.

One notable difference is that the machine code 320 often lacks the high-level abstractions present in the interpreter instructions 310. It doesn't contain recognizable variable names, function calls, or control structures commonly found in programming languages. Instead, it operates on registers and memory locations directly, requiring a deep understanding of CPU architecture.

While the interpreter instructions 310 are typically portable and platform-independent, the machine code 320 is specific to the underlying hardware architecture. Consequently, machine code optimizations can vary depending on the CPU's features, cache hierarchy, and instruction set architecture.

### Example 4—Example Consolidation of Interpreter Instructions

From the interpreter instructions 310 of FIG. 3, it can be seen that even a simple query can result in many interpreter instructions, or many executions of particular instructions, particularly when operations such as aggregations or table scans are being performed (for example, because of operations being performed in a loop). Join operations can similarly result in many executions of a set of particular interpreter instructions.

As explained in Example 1, some overhead associated with executing interpreter instructions can be considered to be “redundant.” Typically, for every instruction, the instruction has to be fetched and dispatched before it can be executed. The present disclosure provides techniques for consolidating instructions. For a consolidated instruction, the fetch and dispatch operations are carried out a single time, reducing overhead and improving execution speed. Further, disclosed techniques replace at least certain instructions with machine code, which can result in faster execution. That is, as described, some interpreter instructions are replaced with machine code, including as part of a consolidated instruction. During execution, machine code only needs to be generated for instructions for which a machine code replacement is not defined in the preprocessing phase. Thus, the technique gains some advantages of compiled code, without requiring full program compilation.

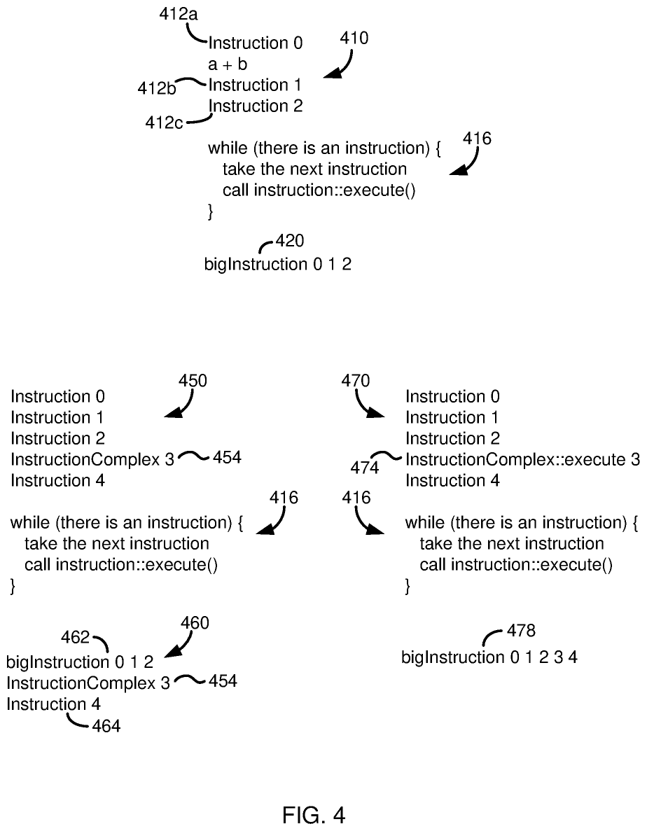

For illustrative purposes, consider the interpreter instructions 410 of FIG. 4 and a simplified interpreter execution loop 416. In instructions 410, instruction 0 (412a) corresponds to an addition operation, while instructions 1 and 2 (412b and 412c) illustrate other types of operations. As described, the execution loop 416 is executed once for every instruction of the interpreter instructions 410. Disclosed techniques consolidate multiple instructions into a single operation, such as where instructions 412a-412c of the interpreter instructions 410 are consolidated into a single “big” instruction 420. Execution of the functionality of the interpreter instructions 410 can now be performed using a single execution of the execution loop 416, with the big instruction 420.

Interpreter instructions, also referred to as instruction nodes (as in some implementations, interpreter instructions can be represented as nodes/particular instances of a node object), can be combined into code snippet. In general, instructions are combined if they are translatable. Being “translatable” can include having an integrated compiler that generates assembly code for specific operations, or where the instruction can otherwise be consolidated, such as through devirtualization, as will be further described.

For translatable nodes, a code generator can be configured to recognize particular types of operations and replace the operations with assembly code. Examples of such operations include integer, Boolean, and pointer arithmetic, member access, and some assignments. In particular, some operations are sufficiently common that assembly code is predefined for a particular execution architecture. That is, the operations are directly implemented in a CPU instruction set.

Interpreter instructions 450 of FIG. 4 illustrate a scenario where not all of the instructions can be replaced by assembly code. For example, instruction 454 is a complex instruction, where a complex instruction can mean that a mechanism for replacing the instruction with assembly code is not defined. Instructions 460 illustrate that the complex 454 instruction is separate from a consolidated instruction 462. In addition, the presence of the complex instruction 454 prevents consolidation of the “simple” instruction 464.

In this case, and as will be further described, the complex instruction 454 can be “devirtualized.” That is, rather than separately calling the execution loop 416 for the instruction 454, the address of the logic function of the complex instruction can be determined and used in a consolidated instruction 470, along with the assembly code for translatable instructions.

Interpreter instructions 470 correspond to the interpreter instructions 450, but where the instruction 454 has been modified to be an instruction 474 that is a call to a specific address of the complex node's logic function. The inclusion of the instruction 474 allows all of the instructions 470 to be consolidated into a single instruction 478.

### Example 5—Introduction to Example Implementation

The present disclosure provides a lightweight assembler that generates program-specific machine code during interpreter start-up, that is, as a preprocessing step. The generator addresses issues resulting from performing an interpreter execution loop on an instruction-by-instruction basis. That is multiple instructions are consolidated in a single instruction that can be processed in a single iteration of the interpreter execution loop.

Consolidation includes replacing some instructions with corresponding machine code. To provide for further consolidation, instructions for which a translation are not defined are “devirtualized.” That is, rather than determining a location (address) for a function during the interpreter execution loop, the function call is resolved in the preprocessing state and is replaced with an execution instruction that includes the location of the function, which then can be carried out in an iteration of the interpreter execution loop along with other consolidated instructions.

The disclosed generator does not provide a baseline compiler that generates a stand-alone executable as quickly as possible. Rather, the generator serves to patch an interpreter with program-specific machine code and devirtualized function calls to make the interpreter more performant. In this way, the existing structure of the interpreter is maintained, which makes the technique easier to integrate into existing technologies. The execution mechanism is not fundamentally changed, but rather the program representation that is executed by that mechanism is modified. Among other things, this approach also makes it unnecessary to implement translation mechanisms for all possible instructions.

The most common instructions are explicitly handled by the generator, less frequent instructions are handled through devirtualization. Therefore, virtually all language aspects benefit from this approach, which significantly improves overall interpreter performance and thus lowers query latency.

Interpreter instructions can be represented as interpreter nodes, such as in a modified version of an abstract syntax tree for a query. An interpreter node holds part of the overall program logic represented by the abstract syntax tree (AST). The node logic is implemented in the node's execute( ) function overload. The execute( ) function is marked as virtual. That allows the interpreter to work with the node base type, which simplifies the interpreter dramatically. However, each call to execute( ) on any interpreter node, during an interpreter execution loop, involves a dynamic dispatch. That is, actual interpreter nodes can be viewed as derived classes of a base interpreter node class.

Nodes are executed either by a GlobalInterpreter or a LocalInterpreter. The GlobablInterpreter handles top-level nodes, like function definition nodes, while the LocalInterpreter manages expressions and statements. Disclosed techniques have particular applicability to the LocalInterpreter.

Each AST node can be identified using a Node Index or Value Index, which it inherits to its corresponding interpreter node. Each interpreter node can then access its value container with that index. The indices are known while the interpreter tree is derived. However, the value containers are generated after the derivation is finished.

A NodeValue can serve as a container for an interpreter node's value. Each NodeValue has information about the contained type and holds a typeless void* pointing to the memory of the managed value. The value might either be a primitive or a structure (which can be referred to as a ValueObject).

Each interpreter node has only one NodeValue. Nevertheless, different Node Values, and thus multiple interpreter nodes, can share the same value by pointing to the same memory. Moreover, there is no node-specific value stack. Node Values, therefore, hold the most recent value.

The following code is an example definition of a Node Value class:

```
class NodeValue {
  protected:
    const NodeValueType* m_type; // 64-bit
    bool m_isTemporary; // 8-bit
    bool m_isWeakRef; // 8-bit
    bool m_isParameterPassByRef; // 8-bit
    NodeRuntimeContext* m_rctx; // 64-bit
// The NodeValue value pointer
void* m_valuePtr = nullptr; // 64-bit
```

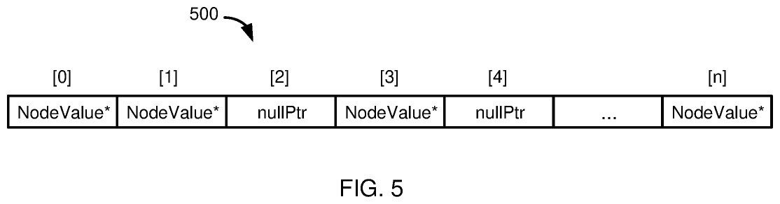

FIG. 5 shows a global array 500 containing pointers to all available NodeValues. The array 500 is generated before constructing the Node Values. There exists a slot for each AST node index. However, only some nodes have an interpreter node equivalent, for which a NodeValue object is allocated dynamically on the heap. Hence, the global array might be sparsely populated.

When an interpreter node needs the intermediary values of its children, it accesses the global array using its node indices and retrieves the Node Value pointers. Using them, it reads the contained values, operates on them, and writes its result back into its own Node Value.

The term Node Isolation refers to the effect that the compiler that builds the interpreter does not know which queries the interpreter will run. Therefore, it does not know what the ASTs of those queries will look like and how those nodes relate to each other.

The compiler only knows the respective execute( ) implementations at compile time, but not how they could be combined for some AST. Therefore, the interpreter is generalistic and not program-specific. The functions, and thus nodes, are not combined but remain separate—hence the term node isolation.

The generalistic execution of queries is less efficient than if nodes were combined. That is because each node's execute( ) function is invoked separately. Each call requires jumping to the target code location, opening a function frame, closing it after executing the function, and returning from the function. Additionally, the dynamic dispatch mechanism is involved in each call to the execute( ) function. That overhead work must be done only once when combining multiple nodes. However, for that to work, a code generator should be employed at runtime—as provided by the present disclosure.

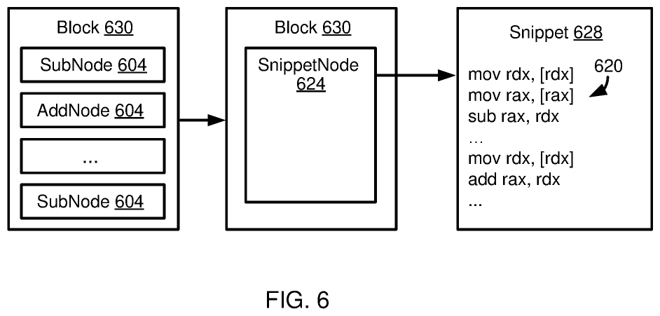

As described, disclosed techniques attempt to combine instruction nodes 604 into one a consolidated instruction, referred to as a machine code snippet, by translating each instruction node to corresponding machine code instructions 620 in a snippet node 624, such as illustrated in FIG. 6. A code unit 630, which can be referred to as a block, then contains only one node, which manages and calls the snippet 628 for that block. That means that an interpreter program (set of interpreter instructions) will consist of multiple snippets when there are multiple blocks (sets of one or more interpreter instructions for a given program).

Combining nodes is possible if the nodes are translatable, which can include replacing instructions with machine code or devirtualizing calls to a node's execute( ) function. Devirtualization eliminates the utilization of the dynamic dispatch mechanism inside machine code snippets for devirtualizable instructions. Devirtualization determines the runtime address of a node's execute( ) function. That runtime address is called inside a machine code snippet directly to circumvent the dynamic dispatch mechanism.

The extraction and propagation of the runtime address is possible because the code generator and interpreter reside in the same system process. Therefore, they share the same address space. Because of that, the runtime addresses are still valid when the snippets are being executed.

Devirtualization provides a default node-to-machine-code translation for all nodes. If a node type is not explicitly implemented in the generator, it can be expressed as a devirtualized call to its existing execute( ) implementation. Devirtualization helps avoid snippet fragmentation. Without the default translation it provides, many nodes would not be translatable as they are not explicitly implemented in the generator. Untranslatable nodes restrict the size of neighboring snippets. That leads to many small snippets, which are interleaved by untranslatable nodes.

### Example 6—Example Node Memory Management

Due to node isolation, nodes go through a Load-Operate-Store cycle. That involves loading operands, performing an operation, and writing the result back to memory. The next instruction loads the result from memory again to use it as an operand.

In order to resolve the overhead from loading results, a basic register allocation can be employed. The register allocation analyzes the relation of nodes and usage of intermediary values and plans register usage accordingly.

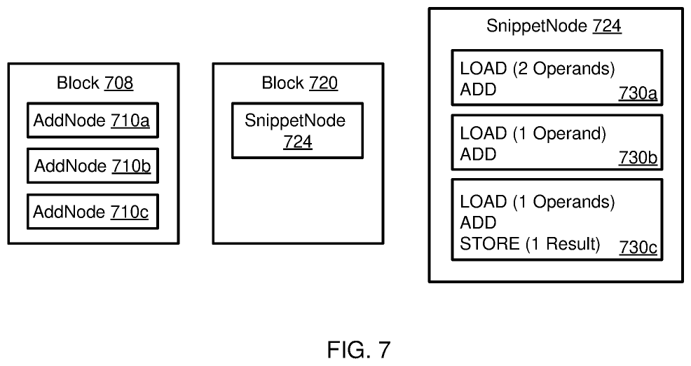

An example of how instructions can be consolidated, and memory managed, is shown in FIG. 7. FIG. 7 illustrates a block 708 of individual instructions 710 (shown as 710a, 710b, 710c). The instructions 710 are consolidated using disclosed techniques to provide an updated block 720, which includes a snippet node 724. The snippet node 724 consolidates the instructions 710, including replacing the interpreter-representation of the instructions with assembly code.

The instructions 710a-710c are represented as instructions 730a-730c in the code snippet 724. The instruction 730a corresponds to an initial addition operator. The operands are not currently available in memory, and so both operands are loaded. The addition operation is performed, and the result stored in a register. The instructions 730b and 730c each add a new operand to the result of the preceding instruction. The results of the preceding instructions are stored in the register, and so do not need to be loaded. The other operand is loaded as part of the instructions 730b and 730c. The instruction 730c is the last “related” instruction, and so after the execution of its addition operation the result is stored to memory.

In some cases, a block, such as a block 708, represents a discrete linear execution path, including as part of a control structure (such as a conditional statement) that has multiple execution paths. By generating code for an individual linear execution path, code generation is simplified, since a generator need only produce sequential code. Logic for operations such as jumps between blocks/code structures can be maintained in a higher-level representation. For example, instructions for these operations are not devirtualized.

### Example 7—Example Assembler Framework

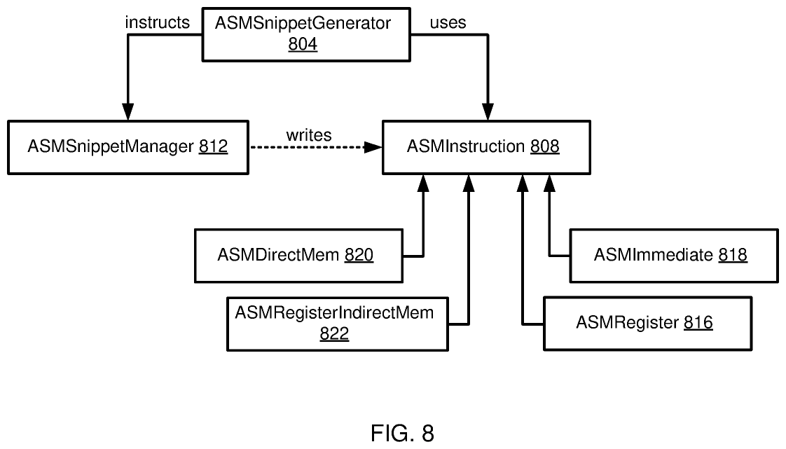

An example assembler used in the present disclosure provides an abstraction with which x86 instructions (or instructions for another processor architecture) can be described componentwise using nested objects. From that representation, the assembler then generates machine code, such as shown in FIG. 8.

The assembler is closely intertwined with a generator mechanism 804. The generator mechanism 804 uses an ASMInstruction class 808 and its children to represent various instructions and operands. With those instructions, it describes the logic of the program. They are given to an ASMSnippetManager 812, which writes those instructions into memory.

The abstraction allows the representation of most x86 operand types. That includes registers (ASMRegister) 816, immediate values (ASMImmediate) 818, memory access using an immediate value (loaded) or a register value (ASMDirectMem 820 or ASMRegisterIndirectMem 822), and memory access with displacements (ASMDisplacementMem) 822. Each type is derived from an ASMOperand base class (not shown), which defines each operand by an operand size and operand value. A 64-bit defines the value integer, while the operand size is defined by an ASMOperandSize enumeration (not shown).

Instructions accept only operands of the ASMOperand base class as parameters. The base class provides helper functions such as isRegister( ) to distinguish the operands from the instructions during machine code generation. Each operand type overwrites its helper function. Without the disambiguation, the value field of an operand lacks a fixed meaning. While the value field expresses a constant value for an ASMImmediate, for an ASMRegister, it expresses the register index. Once the operand type has been determined the interpretation of the value is unambiguous.

Furthermore, the operand types can have static constructors that provide default values or facilitate the definition of an operand. For example, the ASMRegister::RAX( ) function describes the x86 register RAX. On the other hand, the ASMImmediate::Imm64( ) and ASMImmediate::Imm32( ) functions describe 64-bit and 32-bit immediate values, respectively.

Lastly, register objects can be cast into different operand sizes using a toSize Variant( ) function, which helps limit the code generator's complexity. That is because the code generator assumes a 64-bit operand by default. However, if the operands of an instruction are smaller than that, the placeholder for the operand in the generator can be converted to the corresponding size.

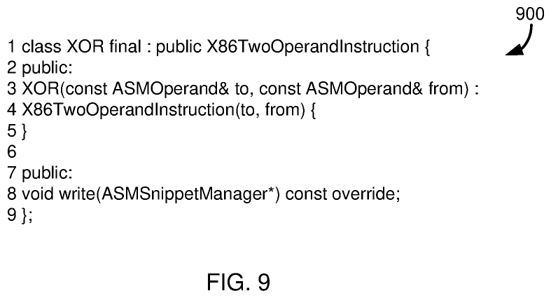

The assembler distinguishes between instructions with no, one, or two operands. Each instruction is defined with its mnemonic as the class name according to the code listing 900 of FIG. 9. The x86Instruction base class provides each instruction type with the write( ) function, which contains the logic for generating the corresponding machine code of that instruction. Each instruction overwrites that function.

The type of instruction determines the number of operands. Initially, any operand can be used as a parameter. When generating machine code from an instruction, it becomes clear whether the specified operand configuration is valid. Operand configurations can either be illegal or merely not implemented. In the case that the operands are not valid, an assertion (error) is triggered.

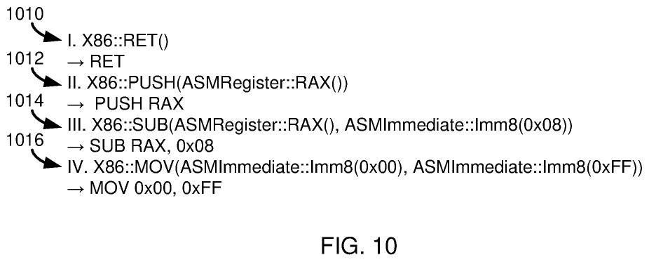

FIG. 10 illustrates example instructions. Instructions 1010, 1012, 1014 are valid examples of instructions of different definition complexity. The last item 1016, however, is invalid, since by definition of the MOV instruction, no constant can be written into another constant.

The assembler is modular and easy to extend. Furthermore, the framework is highly flexible due to the component-by-component definition of instructions through object nesting. Thus, instructions can be easily modified, and even defined at runtime by dynamically generating and inserting operands.

Moreover, the representation of the instructions is similar to actual assembly instructions in terms of syntax. That simplified debugging and code comparisons. The abstraction decouples logic generation using x86 instruction objects from the actual machine code generation, significantly reducing complexity.

Each instruction implements the write( ) function that describes the instruction-specific machine code generation. The complexity of the implementation depends on the number and type of operands.

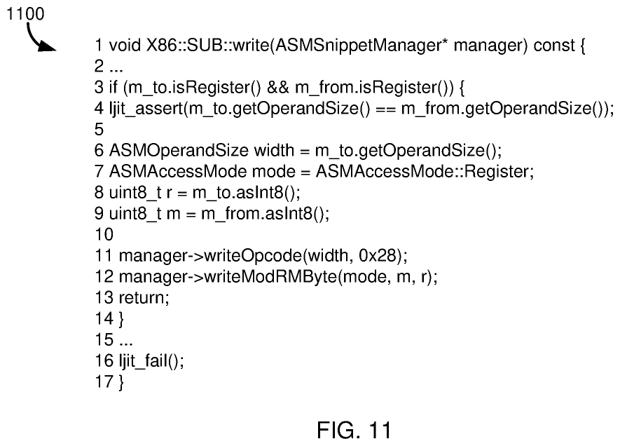

A code listing 1100 of FIG. 11 shows an example implementation of the SUB instruction for the case where both operands are registers. An assertion is placed at the end of the write( ) function that reports logical errors. If an operand configuration is supported, the corresponding machine code is generated, and the function returns. However, if the configuration is not supported, the function executes the assertion at the end. That ensures that machine code is always written. Otherwise, the assertion is triggered.

In this case, the generator expects that both operands are registers of the same size. A smaller register can be subtracted from a larger one, but the size restriction simplifies code generation. Since both operands are registers, their values are interpreted as register indices. Also, it can be deduced from the operand configuration that register-direct addressing is used.

Finally, the instruction is encoded. The writeOpcode( ) function writes prefixes and the opcode of the instruction into the snippet. Depending on the operand size, different prefixes are used.

The base opcode 0x28 is used in this case. If the operands are at least 16 bits large, the base opcode is offset by one. The opcode is followed by the ModR/M byte, which identifies the registers used in the instruction. When the function returns, the machine code generation for the SUB instruction is completed.

Some instructions also have irregular features that make code generation inhomogeneous. For example, some x86 instructions have separate opcodes when the RAX register is used. Otherwise, a different opcode applies. The modularity of the assembler makes it possible to implement only the simple and most important aspects of the x86 architecture to provide simple code generation rather than being forced to implement the entire x86 encoding scheme.

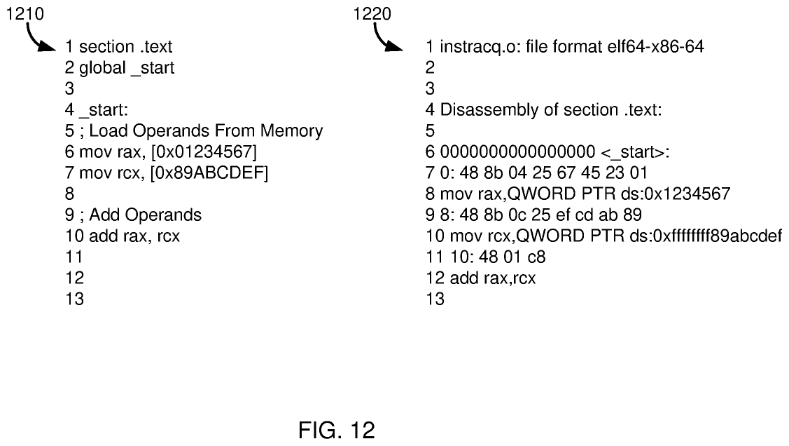

Extensive documentation exists for x86 instructions, their encoding, effects and distinctive features. An alternative is to create a .asm file on the machine with the target architecture, write instructions of interest in assembly language into it, and finally compile it into executable machine code on the platform using assemblers such as Netwide Assembler. The generated binary is then dumped, and its machine code is disassembled into human-readable assembly code. FIG. 12 illustrates an example NSM assembly 1210 and a corresponding object dump 1220.

For simple instructions, the encoding scheme can be read directly from the object dump. More complex patterns can be found by carefully selecting and varying assembly instructions and operands. That way, simpler encoding patterns can be found for instructions that replicate the encoding behavior of the much more complex underlying x86 encoding scheme. That allows machine code generation to construct more complex instructions without implementing the complete encoding scheme.

A machine code snippet is a sequence of instructions in executable memory that captures the devirtualized and compactified logic of multiple nodes. Snippets are generated during the program compile time-so while the interpreter prepares the program interpretation-based on the nodes of the corresponding blocks. Each snippet is characterized by the start and end address of the continuous memory sequence in which its instructions are located.

Since snippets are created at runtime, memory on the heap is dynamically requested to store the machine code instructions. The memory should be set to executable instead of writable after writing the instructions so that the contained bytes can be interpreted as instructions instead of data.

A memory page is the smallest memory unit that can be set to executable. However, the amount of bytes needed to translate the nodes has yet to be determined. Accordingly, it is also unknown how many pages are needed. Therefore, it may not be possible to pre-allocate memory.

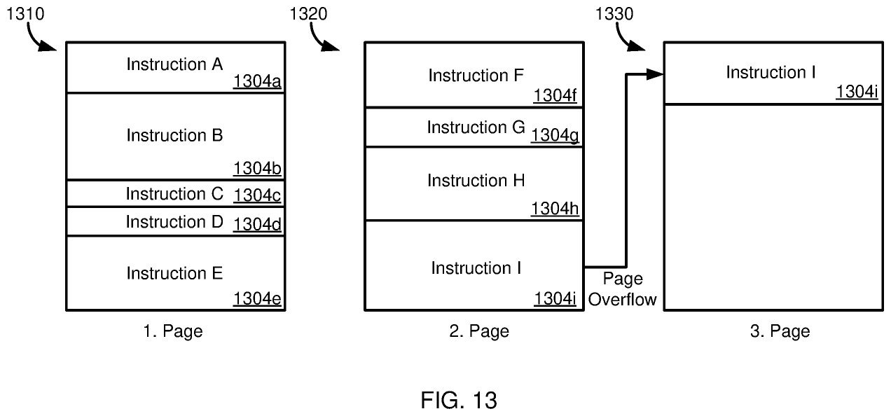

Instead, a memory page is requested initially. The first instructions are written into this page. A new memory page is requested on the heap if the page is full. FIG. 13 illustrates this mechanism. In particular, FIG. 13 illustrates instructions 1304a-1304i stored on pages 1310, 1320, 1330. Instruction 1304i is too large to store on the page 1320, and so overflows the page and is also stored on page 1330. In this way, memory waste is minimized by requesting only the required memory pages.

However, that leads to the effect that related snippet instructions can be distributed on non-consecutive memory pages. However, the instructions should be sequential in order to be executed one after the other.

To solve this, the snippet manager, which takes care of the memory management and writing into snippets, keeps a global counter for the total written bytes. The counter is not reset after allocating and writing to a new page. A snippet stores the state of the counter before the first instruction is written and after the last instruction is written to mark its start and end bytes.

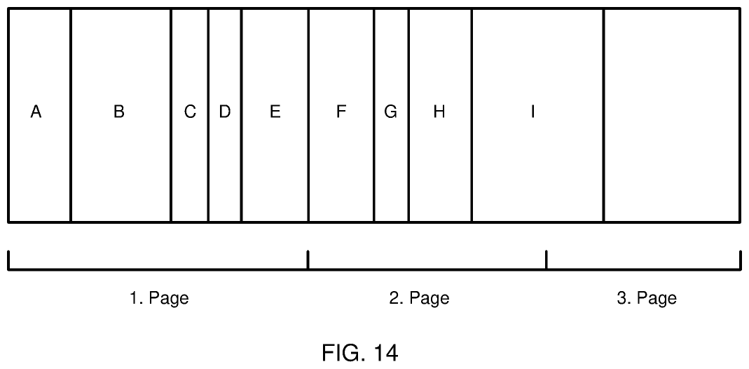

After all instructions have been written, the total memory consumption is known. Then, a global memory block is created for all snippets, which is as large as all temporary pages combined, as shown in FIG. 14.

After allocating the large block, all temporary blocks are copied in the correct order. That makes all snippets sequential again. The start and end markers of a snippet now serve as an offset from the start address of the large block to calculate the final start and end addresses of that snippet.

If code crashes, a diagnostic trace of the call stack can be used to show at which point the crash occurred. That also applies to the generated machine code. For that, the crash handler needs information about the code. Since the machine code is generated at runtime and was not generated by the compiler, that information is not automatically available but is generated and made public afterward.

A language in which the interpreter is written can encapsulate that information in an object. The object contains a function's start and end address and its name. In the case of a snippet, the start and end addresses of the associated instruction sequence and a placeholder name are specified. The placeholder name is based on the function in which the corresponding snippet is present. Finally, the information object is passed to the runtime system to make information available for the trace in the event of a crash.

After generating and registering a snippet, everything is prepared for execution. The snippet has been assigned to an ASMSnippetNode and is represented by a callable function pointer.

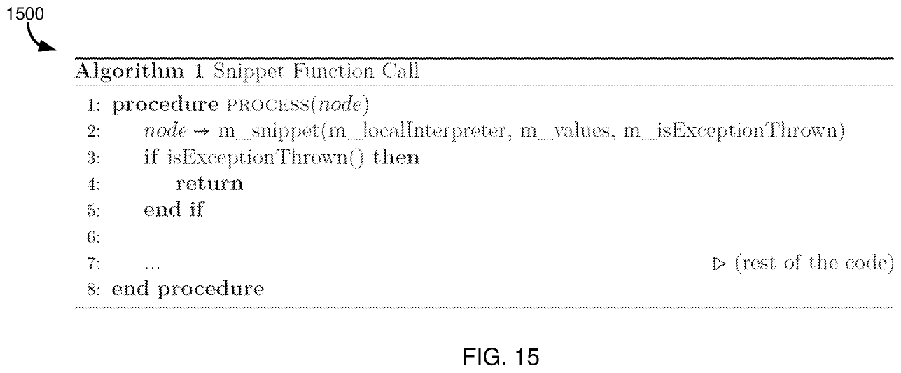

The execute( ) function of the ASMSnippetNode calls the process( ) function of the LocalInterpreter with the node as a parameter. Then, the function pointer of the node into the snippet m_snippet is queried and invoked with arguments. That triggers the function call mechanism, which automatically enters the snippet function, executes all instructions, and returns from the snippet back into the LocalInterpreter, as shown in the algorithm 1500 of FIG. 15.

After the snippet function returns, it is checked whether an exception was thrown while the snippet was being executed. If an exception has been thrown, the m_isExceptionThrown flag has been set to true. In that case, the snippet node's process( ) and execute( ) functions return early as well.

The generation of snippets is integrated into the creation of blocks, which can prevent snippets from spanning more than one block. A block creator can hand over the instructions to a block in the order of execution. The corresponding instructions can also be written in the correct order into the snippet by intercepting the nodes during block creation.

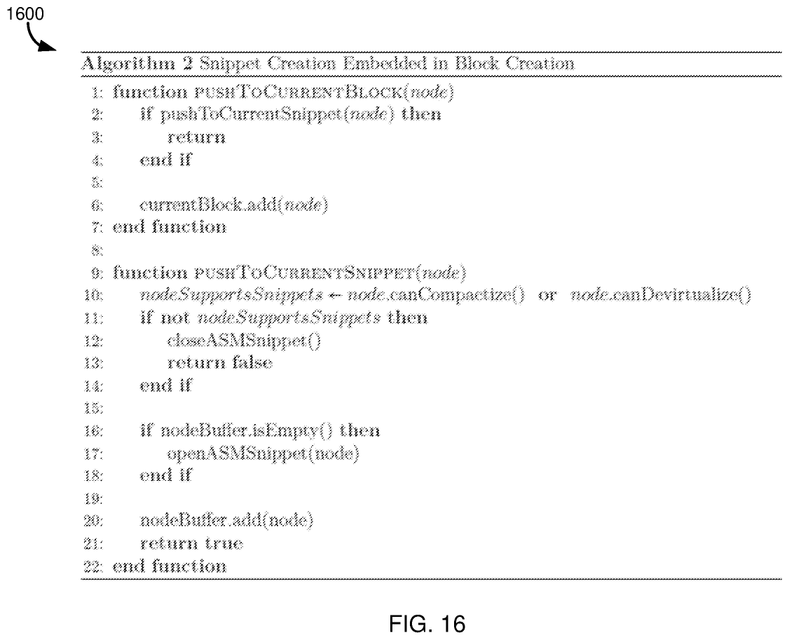

In order to create a snippet, the corresponding nodes are searched and grouped. Algorithm 1600 of FIG. 16 shows how the nodes are bundled into a snippet. The pushToCurrentBlock( ) function of the BlockInstructionCreator is responsible for constructing instruction blocks. The pushToCurrentSnippet( ) function is interposed in that procedure. It checks whether the incoming node is translatable and, thus, should belong to the current snippet. If that check is successful, the pushToCurrentBlock( ) function returns early. As a result, the node is not added to the block but to the snippet.

The push ToCurrentSnippet( ) function checks for nodes that are either compactifiable or at least devirtualizable. Otherwise, there is no machine code translation for that node. If a node is not translatable, the snippet is closed. That is done using the close ASMSnippet( ) function. After that, the function returns false, which puts the non-translatable node into the block in the push ToCurrentBlock( ) function.

However, if a node is translatable, either an active snippet exists or a new one is created. If the node buffer is empty and thus no node is stored for a snippet, a new snippet can be initialized with the openASMSnippet( ) function.

Each translatable node is placed in a buffer for the current snippet instead of being written directly. That allows the nodes to be grouped first, and then, based on the number of nodes, it is decided whether a snippet is worthwhile. If it is, the corresponding memory with the translations of the nodes is written when the snippet is closed.

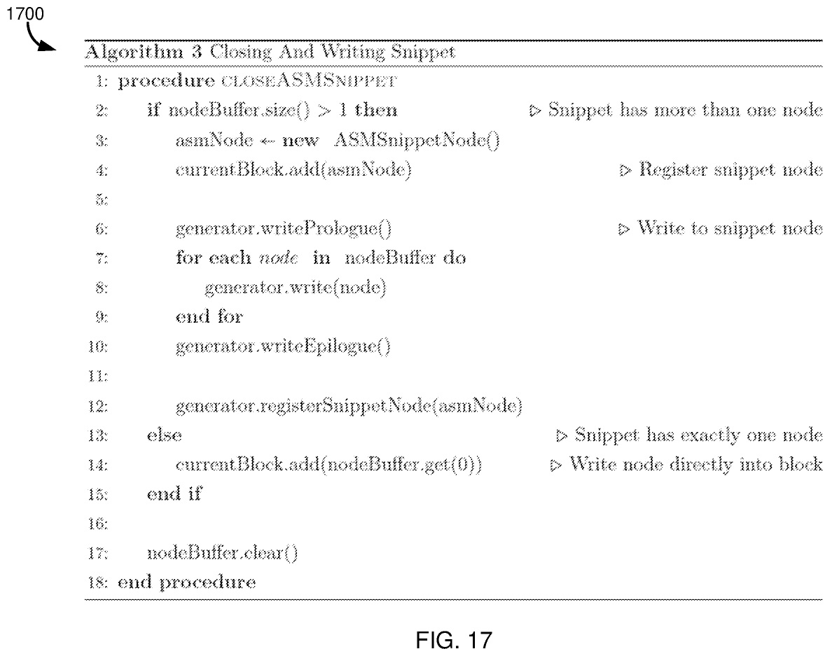

Calling the closeASMBlock( ) function writes the buffered nodes to the snippet, as shown in algorithm 1700 of FIG. 17. That happens when the block is finished, and no further instructions are available or when the generator encounters nodes that cannot be translated.

If the buffer contains only one node, the snippet is not generated, and the node is placed in the block instead. That is because snippets cause a noticeable overhead if they only map one node. In that case, a virtual function call and the call of the snippet function are used, whereas only one virtual function call is used if the node is directly placed into the block.

However, a ASMSnippetNode is created if enough nodes are present. That node encapsulates the snippet to be integrated into the existing execution mechanism. Finally, this node is placed into the block.

First, the prologue of the snippet is written. Then, each node from the snippet's buffer is passed to the generator's write( ) function. The generator then decides which generator function to call based on the node. Finally, the epilogue of the snippet is written. That concludes the coding of the snippet.

However, the addresses of the generated snippets are final once all snippet memory pages have been combined into one continuous memory block. The ASMSnippetNode is registered as the owner of the snippet that has just been generated so that it can later be assigned the final pointer into the snippet function.

When a snippet is closed, the associated nodes are written via the write( ) function, which selects the appropriate generator function based on the node. It allows the decoupling of the snippet generation from the machine code generation.

First, whether a node can be compactified or must be devirtualized is checked. If the latter is the case, a devirtualized call to the implementation function of the node is written into the snippet. However, if the node is compactifiable, node properties determine which generator function must be called.

The node is gradually converted to various derived node types that imply certain operations (e.g., BuiltinBinaryCallNode). If a conversion is successful, the corresponding generator function is called, and the write( ) function returns early.

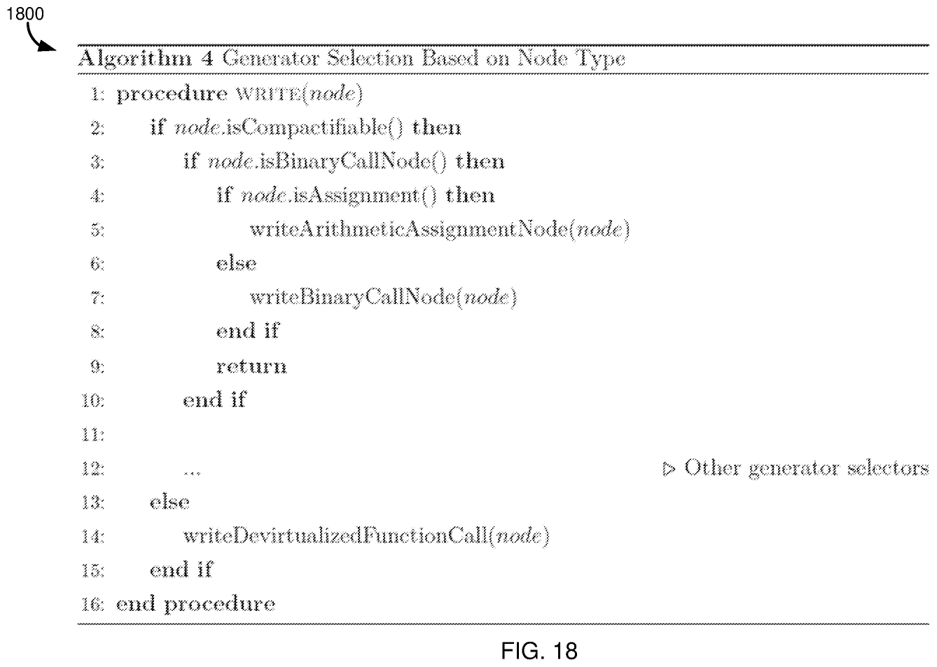

Algorithm 1800 of FIG. 18 shows a minimized variant of the selection mechanism. First, a compactifiable node is checked with isBinaryCallNode( ) to see if it represents a binary operation. If it does, it can either be an assignment, which is handled with writeArithmeticAssignmentNode( ) or it is a more general binary call handled with writeBinaryCallNode( ) In one implementation, a total of six different selectors are available. They cover unary calls, binary calls, member selection operators, and various assignments.

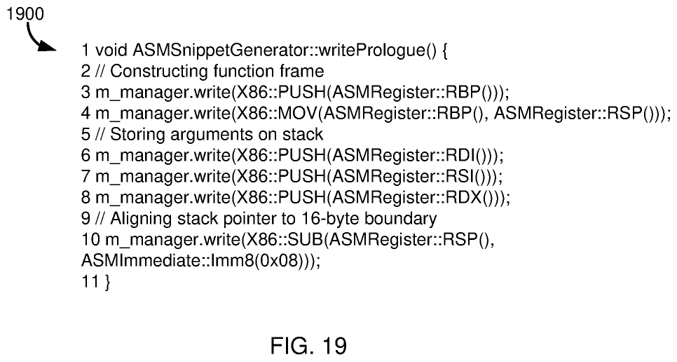

The prologue starts by constructing a function frame for the snippet function. To do this, it saves the current RBP of the previous open frame on the stack. Afterwards, RBP is set to the value of RSP. Thus, a new function frame has been opened. FIG. 19 presents an example code listing 1900 for a function to write a function prologue.

Afterward, the arguments used to call the snippet are also stored on the stack. The arguments are stored according to the System V ABI calling convention in the RDI, RSI, and RDX registers. Finally, the RSP is shifted by eight bytes to align it to a 16-byte boundary, which is also specified in the calling convention.

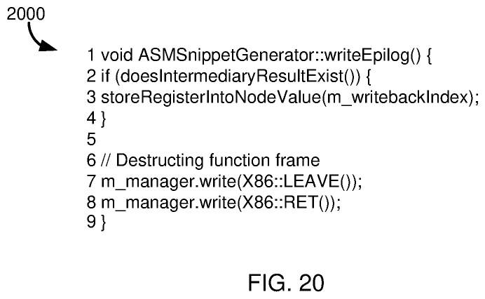

In contrast to the prologue, the epilogue takes care of exiting the snippet function. First, it checks whether an intermediate value exists in one of the registers. If that is the case, the value is stored into memory. FIG. 20 presents an example code listing 2000 for a function to write a function epilogue.

Then, the function frame is deconstructed. If none of the registers are call-preserved, none need to be restored. The epilogue closes the function frame with the LEAVE instruction. Using the RET instruction and the return address stored on the stack control flow goes back to the LocalInterpreter that called the snippet initially.

If a C++ exception is thrown, execution is paused, and error handling sets in. The runtime system first searches for a suitable exception handler. To do this, it examines the call stack in reverse order, starting where the exception was thrown and moving up the call stack. It searches for catch blocks corresponding to the thrown exception type.

If no suitable handler is found, an uncaught exception error is propagated, which can lead to a process crash. However, if a handler is found, the current frames up to the exception handler are unwound to restore a safe state.

When unwinding a frame, the call-preserved registers are restored, a task typically performed by the epilogue at the end of a function. However, due to the exception, a function is interrupted before it reaches the epilogue. The status of the registers, however, depends on the code location in the function when an exception occurs. In order to be able to unwind at any position in a function, an unwind table is used, which describes how a function can be unwound at each position in that function.

Usually, the compiler puts information describing those unwind tables into the .eh_frame section of an executable. Therefore, that information is not automatically available for dynamically generated code, as the compiler does not know it. Without that information, the runtime system cannot unwind snippet functions if an exception is thrown in a devirtualized function call. The exception cannot be propagated through the call stack, resulting in an unhandled exception.

In order to help avoid crashes of the interpreter, nodes that can throw exceptions can be excluded from snippet generation. They are neither compactified nor devirtualized. This way, the approach is stable in the absence of exception handling. However, since only a few rarely occurring nodes are excluded from snippet generation, the performance impact is negligible.

### Example 8—Example Consolidation

As explained above, one feature that helps implement instruction consolidation, also referred to as “compactification,” is register allocation. Register allocation provides registers for operands and schedules their use. The allocation ensures that operands are loaded, and intermediate values are saved in the registers. Furthermore, it ensures that intermediate results from the registers are reused for subsequent operations, thereby drastically reducing memory accesses.

In one example, register allocation supports three registers, all of which are call-clobbered (are not preserved across a function or subroutine call). Therefore, they do not have to be restored, which makes the epilog logic easier. In addition, those registers are assumed to be 64-bit registers for simplicity. Their sizes can be adjusted, such as when an instruction uses smaller operands.

The OPERAND_ONE register is a placeholder for the physical RAX register. It is one of the two available operand registers. In the case of a binary operation, it typically represents the left side (LHS) of the expression. In the case of unary operations, it directly represents the unary operand. It is a property of the x86 architecture that the result of an instruction is usually written to the RAX register. Therefore, the intermediate results of operation chains are stored in RAX after each operation. The result can be reused directly. Thus, only one operand must be loaded for the following operation, reducing memory access.

The OPERAND_TWO register is a placeholder for the physical RDX register. It is one of the two available operand registers. In the case of a binary operation, it typically represents the right side (RHS) of the expression. As the intermediate result is stored in RAX, the second remaining operand of binary operations is loaded into RDX. Moreover, the register is used to write back the intermediary result of an operation. The result is stored in RAX and the operand in RDX is no longer needed as the operation is finished. Therefore, it can be used to determine the address to which RAX should be saved.

The HELPER register is a placeholder for the physical RCX register. In contrast to the operand registers, the HELPER register is also used for devirtualization. It holds the address of the devirtualized execute( ) function, and it is used for handling program exceptions after devirtualized calls. During compactification, it is used as a fallback register for special operations so that operands can remain in their registers during intermediate computations. It is used, for example, to determine bit masks for shifts or to perform the division in a pointer subtraction.

Three nodes are involved in a binary operation, each with its own node indices. These include the two operands OP1 and OP2, as well as the instruction INSTR. First, the OP1 and OP2 operands are loaded. Then, the operation is executed, and the intermediate result is stored in RAX. The result belongs to the instruction INSTR. Therefore, it should be stored into its NodeValue. Instead of storing the intermediate result, the allocator remembers to which index the result should be written. That index is called the Writeback Index. In addition to the index, the bit width of the operand, the writeback width, is also noted.

The subsequent operation checks whether the writeback index of the intermediate result in RAX corresponds to one of its operands. If that is the case, that operation uses the intermediate result directly. That means that one less operand has to be loaded from memory. However, if the subsequent operation does not need the intermediate result, the result is written back to Node Value at the writeback index.

Assuming a sequence of additions of length n, there are 3n memory accesses for that sequence if intermediate values are not reused. That is because two operands are loaded for each addition, and the intermediate result is stored. However, only n+2≈n memory accesses are needed when intermediate values are reused. Then, each addition loads only one operand. Exceptions are the first addition, which loads a second operand, and the last addition, which stores the total result.

The second argument with which a snippet function is called is the pointer to the global Node Value array. According to the calling convention, that pointer is passed to the function via the RSI register. The prologue then saves all arguments on the stack.

When the generator is in compactification mode and combines several nodes, that pointer is loaded into the RDI register. Initially, the pointer points to the first element in the global NodeValue* array. The generator also maintains a NodeValue Index that expresses which element the pointer in RDI is currently pointing to. That index is equivalent to the index of the corresponding node.

The NodeValue pointers are selected via that register for reading and writing. If another Node Value* is to be selected, the array pointer is increased or decreased according to the delta between the indices. That way, the array pointer can remain in the register, and the base pointer does not have to be read from the stack and then offset on each Node Value selection. The mechanism works with indices, which are already known during code generation. The Node Values behind them are only allocated in the last step before execution, so no addresses are available until then.

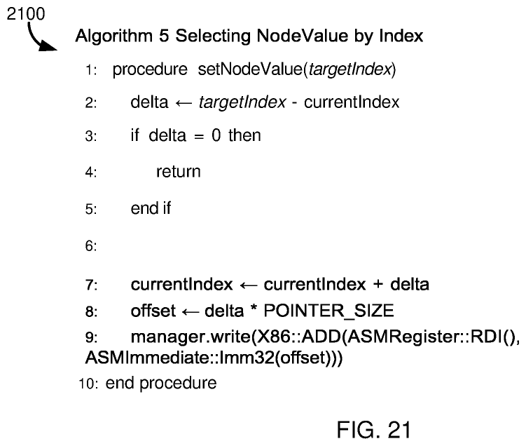

Algorithm 2100 of FIG. 21 illustrates how the setNode Value( ) function performs the Node Value selection. First, the delta between the indices of the current and the requested NodeValue is calculated. If both Node Values are different, the delta is not zero. Each element in the continuous array has a certain size in bytes. The array pointer is, therefore, moved by the width of the elements times the number of elements in between. That byte offset is added to the pointer in the RDI register to point to the desired Node Value*.

For simplicity, the offset can always be added to RDI. If the desired Node Value has a smaller index than the current Node Value, a very high offset is calculated, which causes RDI to overflow, so that it is moved back a few elements in the array, pointing to the requested Node Value*.

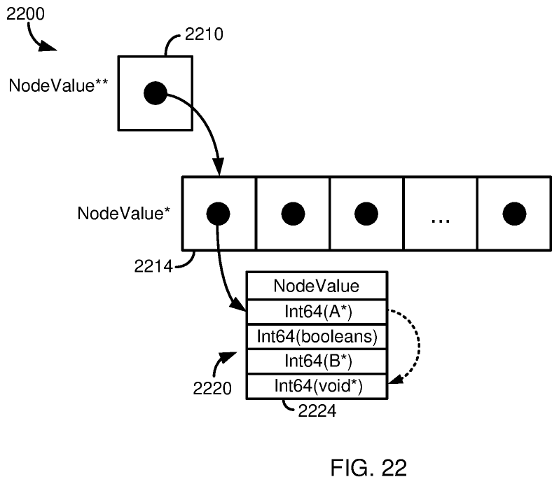

However, that only selects the elements in the global array. Each element is a pointer pointing to their actual Node Value object. FIG. 22 shows a data structure 2200 of the NodeValues as a whole. An array pointer 2210 points to the selected Node Value* element 2214. The pointer 2210 in the RDI register is dereferenced to get the address to which the selected element points. This address points to the beginning of the Node Value object 2220. The address must be offset so that it points to the Value Pointer 2224 of that Node Value.

That field, in turn, holds the pointer to the actual value of the NodeValue at the given index. Therefore, that pointer must also be dereferenced after offsetting it.

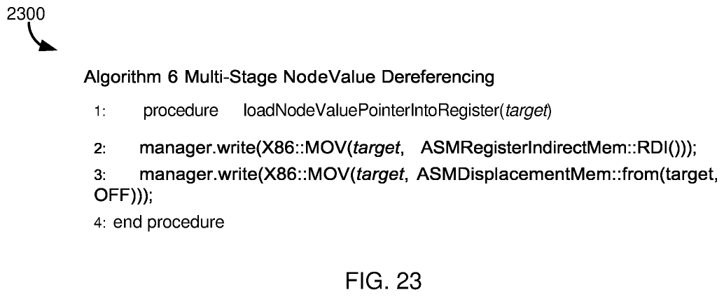

The loadNodeValuePointerIntoRegister( ) function shown in algorithm 2300 of FIG. 23 does exactly that. It dereferences the NodeValue** in RDI to a Node Value* into the target register. The target register can be either OP1 or OP2. Then, the Node Value* in the target register is dereferenced again with a displacement (offset) to the value pointer. The value pointer is now available for reading and writing in the target register.

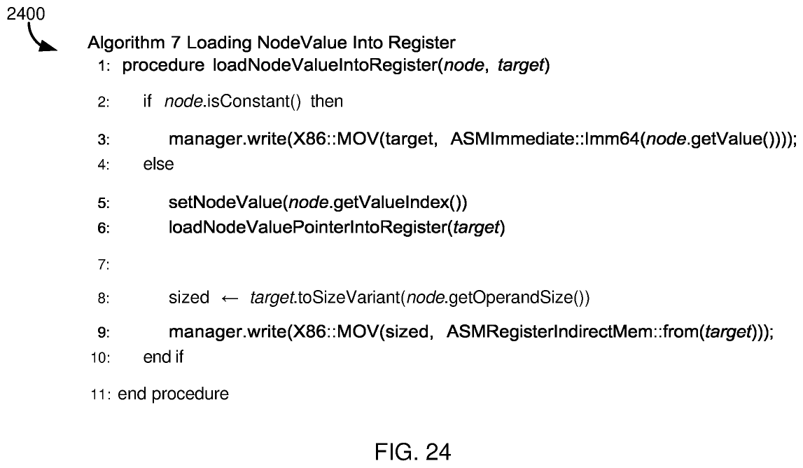

The function loadNodeValueIntoRegister( ) loads the stored value of a node into the specified target register, as shown in algorithm 2400 of FIG. 24. First, it is distinguished whether the node has a constant value. If the value is constant, it is loaded directly into the target register as an immediate value.

Otherwise, the Node Value* of the node is first targeted with setNodeValue( ) Using the loadNodeValuePointerIntoRegister( ) function, the value pointer is loaded into the register.

Now, the target register, which is assumed to be a 64-bit register by default, is scaled according to the operand size of the node. Then, the value pointer is dereferenced and loaded into the scaled register in the corresponding size.

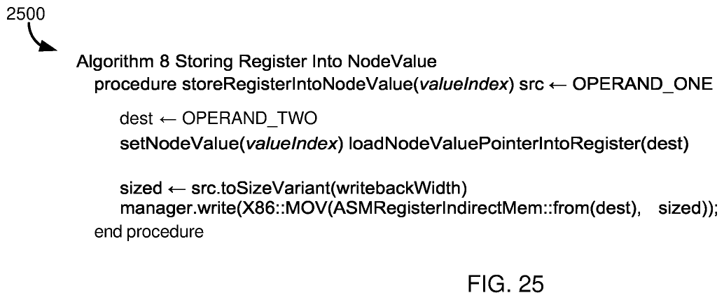

The function storeRegisterIntoNodeValue( ) stores the intermediate result, which is in RAX, into the Node Value at the specified value index, as shown in algorithm 2500 of FIG. 25. Again, the NodeValue* is targeted first.

Then the value pointer is loaded into the OPERAND_TWO register. That register is also scaled using the writeback width. The value from OPERAND_ONE is written to the address referenced by the value pointer in the corresponding operand size.

Reading from and writing to Node Values can be expensive. Each time the value pointer is retrieved, the index in RDI is adjusted, and two dereferences are performed. When writing and reading, further dereferencing is performed. Memory accesses are comparatively expensive, even with cache. Accordingly, access to the embedded value of a NodeValue has a significant influence on performance. Interaction with the memory can be reduced through register allocation and writeback indices.

Binary operations are implemented by the generator function writeBinaryCallNode( ) First, some values are queried, including the binary operation, the two operand nodes, and their indices and the index of the operation node. That is followed by the register allocation, which ensures that the operands are present in the correct registers.

If an intermediate result corresponds to the expression's left side (LHS), the right operand must be loaded. However, if the intermediate result represents the expression's right side (RHS), the left operand must be loaded. Note that the commutativity of the operation is taken into account. That is because the intermediate result of RHS is in the register (RAX) which is intended for LHS. If the operation is commutative, the order of the operands does not matter, and the left operand can be loaded into the RHS register instead. Otherwise, the register values are swapped beforehand, and the left operand is loaded into the LHS register.

If no intermediate result exists or does not correspond to any of the operands, both operands are loaded into LHS and RHS using the loadNodeValueIntoRegister( ) function. If the intermediate result exists but does not correspond to the operands, it is not relevant for this operation and is saved to the writeback index.

After the register allocation follows the generation of the operator logic. Based on the node, it is decided whether pointer operations or integer operations are involved. The generator function is selected accordingly. The intermediate result of that operation will reside in the RAX register again. Finally, the operation node is set as the writeback target.

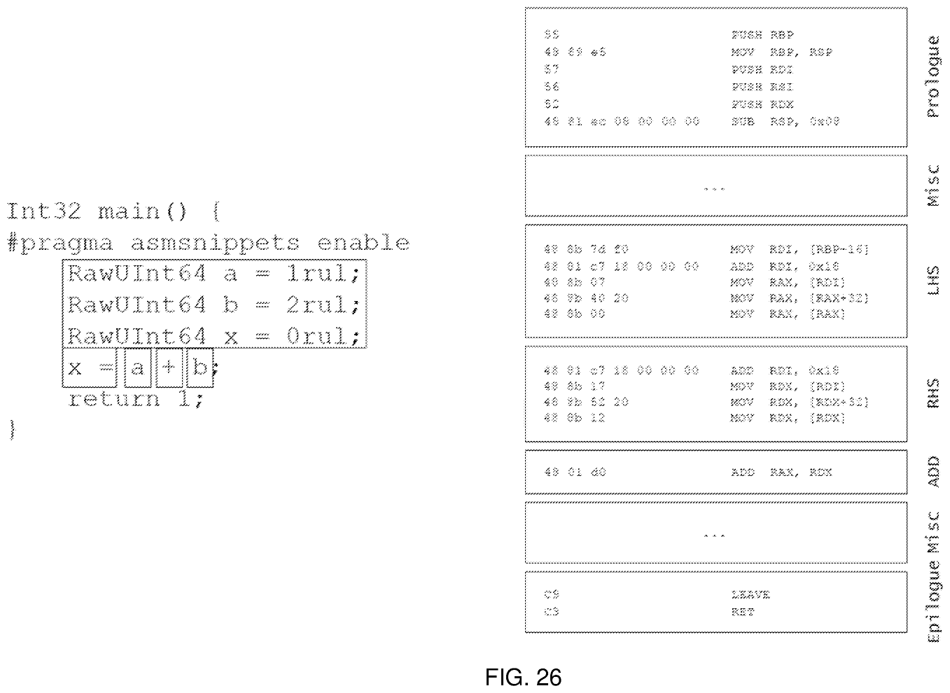

FIG. 26 shows an example translation of interpreter code to machine code. Each language component is color-coded according to its translation. The snippet starts with the prologue. That is followed by devirtualized function calls for the variable declarations. These have been omitted here so that the essence of the binary call remains visible.

Before the binary operation, the values of the operands LHS and RHS are loaded into the registers. Then a single ADD instruction is executed. It fully covers the logic of the addition. The intermediate value is then assigned to the variable x and written to memory. Finally, the epilogue ends the snippet.

It is noticeable that the majority of the instructions do not map to the core logic, but are responsible for managing the snippet and allocating registers. For larger snippets, the relative size of the epilogue and prologue to the total size decreases, but for each operation, the registers should be managed. Thus, the proportion of core instructions remains small even as the snippet size increases.

Plain assignments are a special kind of binary operator. They are implemented by the writePlainAssignmentNode( ) function. It covers variable assignments, but without declaration, as this can throw exceptions.

First, the two operands and the index of LHS are queried. Then, if no intermediate result exists in the registers, the assignment value is not yet loaded. Therefore, the RHS is loaded, and the LHS is defined as the writeback target, where the intermediate result is stored. The data transfer between the operand nodes performs the assignment. Since assignments cannot be concatenated, the writeback target is set to none.

Arithmetic assignments (e.g., a+=b) are a mixture between assignment and binary operators. First, they perform an arithmetic operation and then assign the result to a variable. Moreover, they are implemented using the writeArithmeticAssignmentNode( ) function.

After the values have been queried, the register allocation takes place. Here, it is checked whether an intermediate result exists. If the result exists but does not correspond to the RHS, the intermediate result is stored, and the RHS is loaded. That is followed by a commutativity check on the arithmetic operation before the assignment happens. Finally, the instructions for the operation itself are written, and a plain assignment is carried out.

Unary operations are implemented by the generator function writeUnaryCallNode( ) First, the operator, the operation argument and its index, and the index of the operation node are queried.

The register allocation ensures that the argument is loaded into a register. If an intermediate value exists but does not correspond to the argument, the intermediate value is stored back to the writeback index. If no intermediate value exists, the unary operand is loaded.

As with binary operations, a distinction is made whether the operation is a pointer or integer operation. The generator function is selected accordingly. Lastly, the writeback index is managed. For the increment (a++) and decrement (a−−) operations, the variable is manipulated directly. The target of the value change is thus the variable itself, represented by the argument of the unary call. Other unary operations (e.g., !a) produce a temporary expression. Therefore, the value of that temporary expression is stored in the operation node that produced it.

Member selections are implemented by the writeMemberSelection( ) function. A distinction is made between direct access to the member of an object (obj.member) and indirect access to a member through the pointer of an object (obj→member).

Member accesses are characterized by the fact that no intermediate result is being produced, but the pointer to the member is determined and then propagated to the operation node.

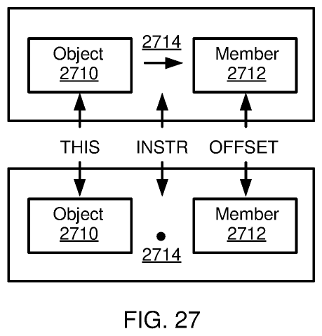

As shown in FIG. 27, first, there are “this” nodes 2710, which represents the object whose member 2712 will be selected. The specified member shows the offset in this object to get to the value of the member The operation node 2714 (either . or →) describes the access mode. The pointer to the selected member is stored in the operation node.

Member selections cannot be concatenated. They do not produce intermediate values and do not expect any. Therefore, the writeback index is reset at the end. Hence, if an intermediate value exists at the beginning of the member selection, the value is stored to the writeback index.

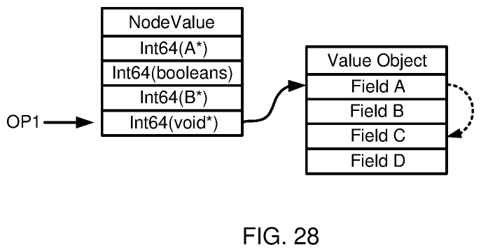

Then setNodeValue( ) is used to access the Node Value of the object node and loadNodeValuePointerIntoRegister( ) then loads the corresponding value pointer into OP1. As FIG. 28 shows, the value pointer points to the beginning of a structure in the case of direct member selection.

However, if it is an indirect access via a pointer of the object, the value pointer first points to the pointer of the object, which in turn points to the structure. Therefore, in the case of indirect access, the value pointer is dereferenced once to point to the structure.

The set ValuePointerForNode( ) function handles the selection of the member in the structure and the propagation of its pointer to the operation node. The value pointer, which points to the beginning of the object, is moved by the offset of the member in the object. Then, the Node Value of the operation node is accessed, and its Node Value* is loaded into OP2. Finally, the pointer from OP1 pointing to the member is written into the value pointer of the Node Value in OP2. Thus, the pointer to the member has been successfully propagated to the operation node.

### Example 9—Example Devirtualization

A main implementation technique used in devirtualization is VTable extraction. That technique finds the final entry address of the execute( ) function in the virtual table of a node. That address is identical during code generation and execution, as both take place in the same system process. The extracted address can, therefore, be written into the snippet during code generation. Then, during execution, a regular function call takes place, and no dynamic dispatch is needed, which significantly affects the performance of the interpreter.

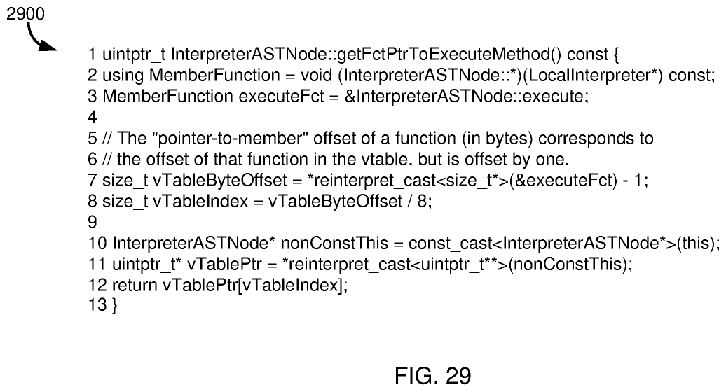

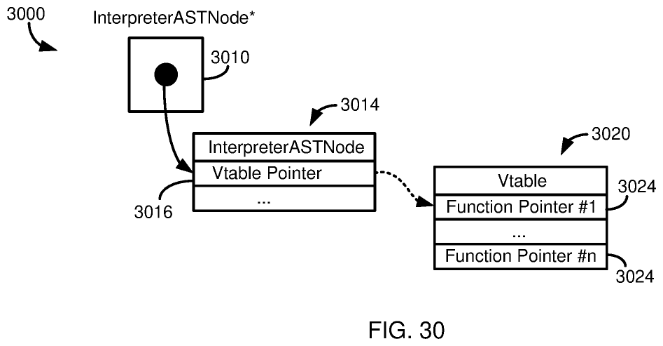

The code listing 2900 of FIG. 29 shows the implementation of the extraction of the entry address into the execute( ) function for the GNU Compiler Collection (GCC) compiler. The GCC compiler obeys the Itanium C++ ABI. First, a so-called “pointer-to-member-function” for the execute( ) function is created. That is a kind of function descriptor. By definition, the pointer-to-member-function of a virtual function corresponds to the offset of that function in the vtable in bytes plus one. FIG. 30 illustrates a Vtable pointer hierarchy 3000.

In order to get the table offset in bytes, the pointer-to-member-function is first converted to an integer (size_t), and one is subtracted. Each entry in the vtable is a void*, which is 8 bytes in size. The offset is divided accordingly to obtain the index of the execute( ) function in the vtable.

Furthermore, the Itanium C++ ABI defines that the vtable pointer occupies the first 8 bytes of an object. Therefore, the InterpreterASTNode* 3010 that points to the node 3014 points simultaneously to the node's vtable pointer 3016.

The vtable pointer 3016, in turn, points to the vtable 3020, which is an array of pointers 3024 to the functions. An array is defined in C++ by the pointer to the initial element. Each entry in the vtable can be represented as uintptr_t. That allows the vtable pointer to be expressed as an uintptr_t*, a pointer to an array of pointers. The InterpreterASTNode*, which points to the vtable pointer of the node, is therefore also a uintptr_t**, a pointer to a pointer to an array of pointers.

That allows us to reinterpret the pointer of a node as its virtual table. Since the virtual table is an array, the calculated index can be used to find the entry address of the function at that index. That way, the function address of the execute( ) function of a node can be extracted from the table.

It should be noted, however, that this implementation can be dependent on the compiler being used. Nevertheless, the entry address of the execute( ) function of a node can be reliably determined for many compilers (including GCC and Clang) so that it can be used to issue devirtualized function calls.

For the function call using the extracted address, the components from the function signature of execute( ) are needed. These are the nodes (this) on which the function is executed and the LocalInterpreter*, which is passed as an argument to the snippet function. According to the calling convention, it was stored in the RDI register and then placed on the stack by the prologue.

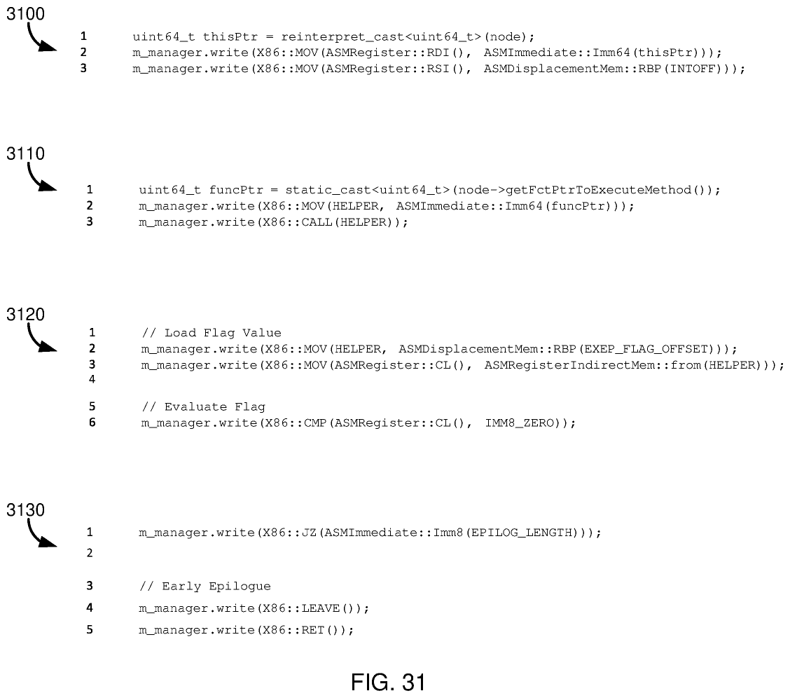

The “this” pointer corresponds to the pointer to the node whose execute( ) function is to be called. The node pointer can be converted to a numerical value (uint64_t) and then written as an Imm64 directly into the RDI register as the first argument. The LocalInterpreter* resides on the stack and can be loaded into the RSI register by offsetting the RBP properly and reading the stack content. FIG. 31 illustrates example code 3100 for devirtualized call argument preparation.

Finally, the entry address into the execute( ) function of the node is determined using the getFctPtrToExecuteMethod( ) function. It is reinterpreted as an integer value and transferred into the HELPER register, from where the devirtualized execute( ) function is called. FIG. 31 also presents example code 3110 for invocation of the devirtualized execute( ) function.

The same LocalInterpreter* is used for each devirtualized call, but the RSI register is not call-preserved. So, the register might have changed after the call. Therefore, the pointer is reloaded into the RSI register for each devirtualized function call.

When calling a devirtualized function, an exception can be thrown. In that case, the markThrow( ) function is called inside the devirtualized function. Initially, when an exception occurs, the execution of the nodes is interrupted and directed to a specialized node that handled the exception.

However, if an exception occurs in a snippet, the snippet is not automatically interrupted. Hence, the boolean flag m_isExceptionThrown is provided. Whenever markThrow( ) is called, the flag is set to true. When calling a snippet, a reference to that flag is passed as an argument to the snippet function. The reference is then stored onto the stack by the prologue. If an exception occurs within a snippet, the flag is set, and its state can be checked within the snippet via the reference after the devirtualized call has been performed. FIG. 31 illustrates example code 3120 for an exception status flag check.

First, the reference of the flag is loaded from the stack into the HELPER register. There, it is dereferenced, and the flag's value ends up in the CL register, the lowest-significant byte of the HELPER register. Finally, the flag is compared with false (=0/IMM8_ZERO), which sets register flags in the processor.

If the processor flags indicate that the exception flag is false, a short relative jump is performed that jumps over an early epilogue. However, if the exception flag is true, the jump is not performed, and the snippet returns early. The choice of registers makes the epilogue trivial. Furthermore, inserting an early epilogue directly means there is no need for placeholders that indicate where a jump to the epilogue at the end of the snippet would be necessary, making code generation more straightforward. FIG. 31 illustrates example code 3130 for an early epilogue and jump.

After each devirtualized call, a check is performed to determine whether a program exception was thrown, even if the function does not throw an exception. That entails considerable overhead for all devirtualized calls. The overhead can be circumvented by selectively excluding nodes that cannot throw a program exception from the generation of the exception handling. In addition, instead of an external flag, a return code can be used, which is produced by a devirtualized function call. According to the calling convention, the return code ends up in the RAX register, where it can be checked directly. That eliminates the need for memory accesses to check the exception flag.

### Example 10—Example Program and Machine Code Snippet Produced Therefrom

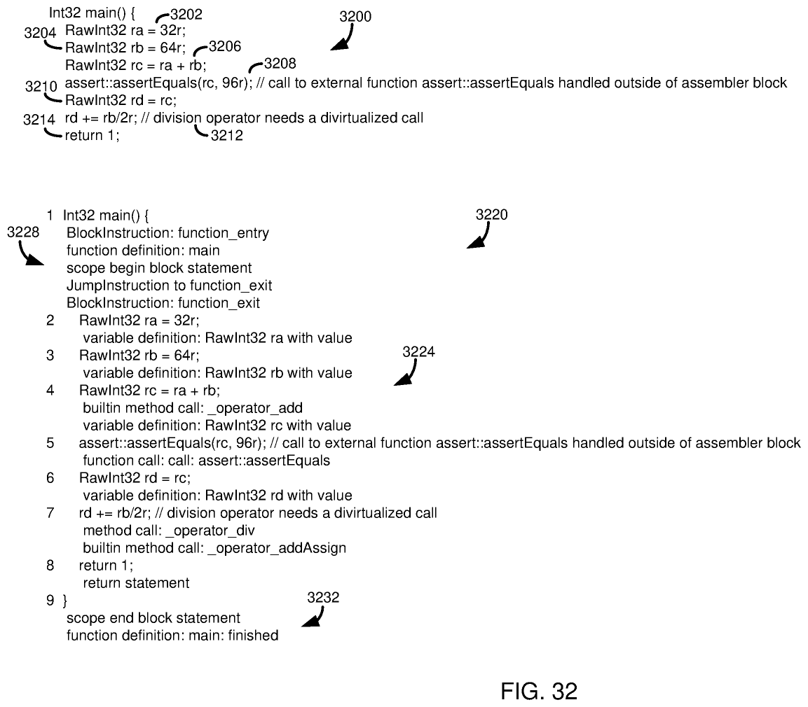

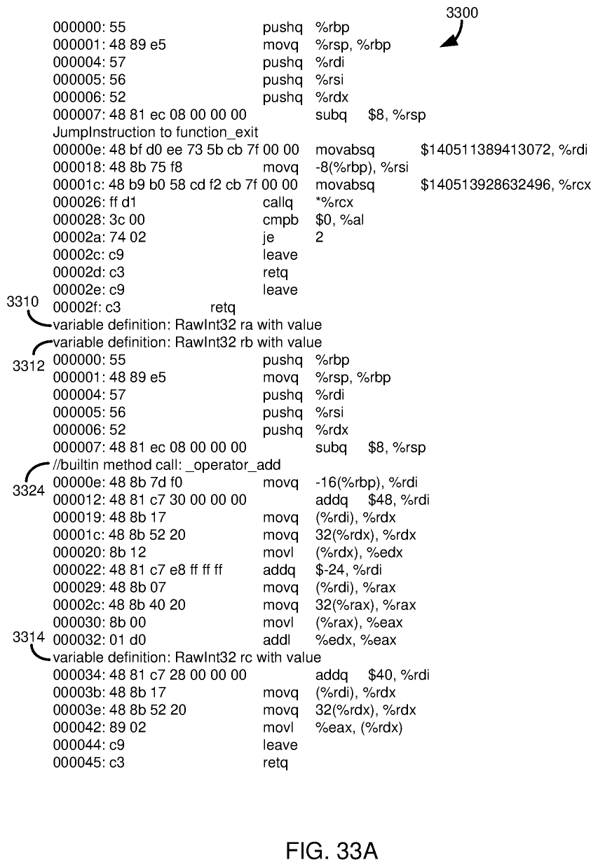

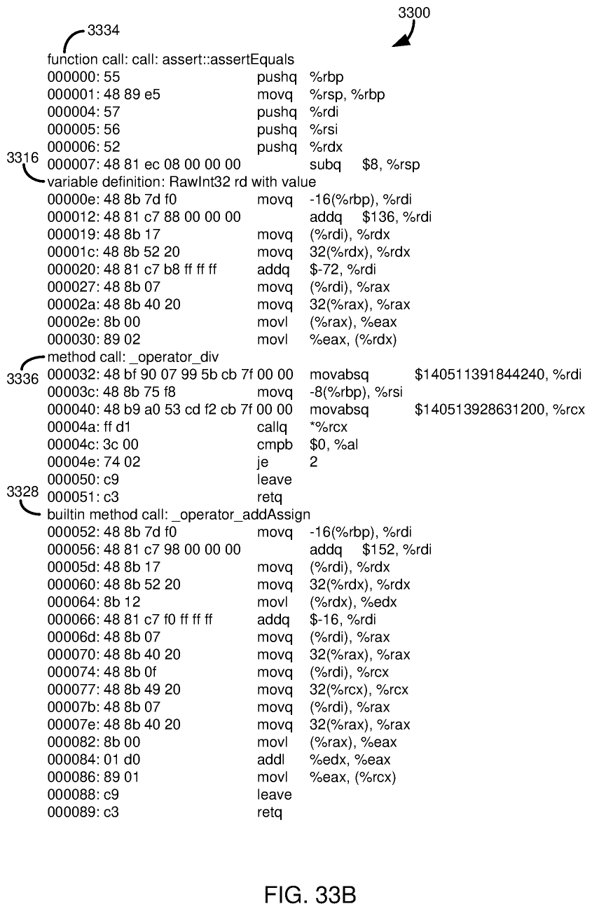

FIGS. 32 and 33A and 33B illustrate how a consolidated instruction/code snippet can be created from a program and interpreter instructions to execute the program. FIG. 32 illustrates a program 3200. The program 3200 includes (1) instructions 3202 and 3204 that, respectively, declare variables a and b and assign values to them; (2) an instruction 3206 that calculates the sum of a and b as variable c; (3) an instruction 3208 that checks to see whether the sum equals 96; (4) an instruction 3210 that assigns the value of variable c to variable d (addition assignment); (5) an instruction 3212 that adds to variable d half the value of variable b; and (6) a return/program termination statement 3214.

In this case, assume that an implementation exists to replace the addition and addition assignment operations with assembly instructions. As described then, the addition and addition assignment operations can be replaced with assembly code when the instructions are consolidated into a code snippet. The declaration and assignment, assertion, and division operations cannot be replaced with machine code, but they can be devirtualized by including the execution address for the instructions in the machine code snippet, rather than resolving the function name to the function address during an execution loop of the interpreter.

FIG. 32 also illustrates interpreter instructions 3220 for the program 3200. The interpreter instructions 2320 includes program instructions 3224 that correspond to instructions of the program 3200, as well as control operations, such as startup instructions 3228 and shutdown instructions 3232.

FIGS. 33A and 33B illustrate a consolidated interpreter instruction 3300 that is produced by replacing the addition instruction 3206 and the addition assignment instruction 3212 with assembly code, and devirtualizing the declaration and assignment, assertion, and division operations. In particular, lines 3310, 3312, 3314, and 3316 contain variable definition statements for variables a, b, c, and d. These variable definition statements can also correspond to devirtualized calls to the corresponding functions. Line 3324 indicates the beginning of assembly code for the addition operation (adding a and b). The use of “builtin” refers to that a method has been defined to generate assembly code for the operation. Similarly, line 3328 indicates the beginning of code for the built-in addition assignment operation.

Lines 3334 and 3336 correspond to, respectively, devirtualized calls to the assert equals and division functions.

### Example 11—Example Operations in Consolidating Interpreter Instructions

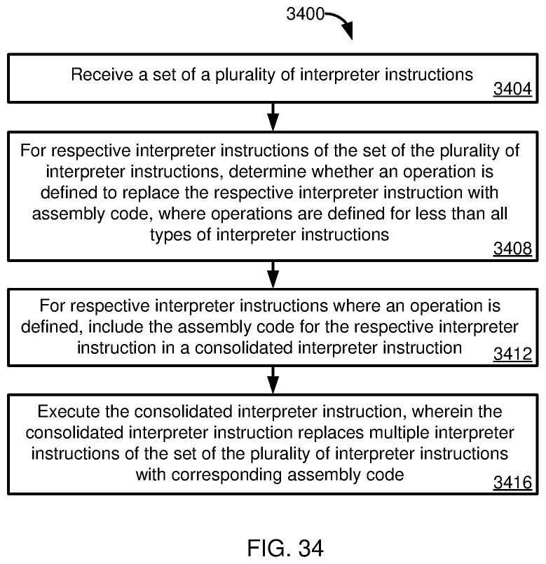

FIG. 34 provides a flowchart of a process 3400 for consolidating interpreter instructions. The process 3400 can allow for interpreter instructions to be executed more quickly and efficiently. At 3404, a set of a plurality of interpreter instructions is received. For respective interpreter instructions of the set of interpreter instructions, it is determined at 3408 whether an operation is defined to replace the respective interpreter instruction with assembly code, where operations are defined for less than all types of interpreter instructions. At 3412, for respective interpreter instructions where an operation is defined, the assembly code for a respective interpreter instruction is included in a consolidated interpreter instruction. The consolidated interpreter instruction is executed at 3416, where the consolidated interpreter instruction replaces multiple interpreter instructions of the set of the plurality of interpreter instructions with corresponding assembly code.

### Example 12—Computing Systems

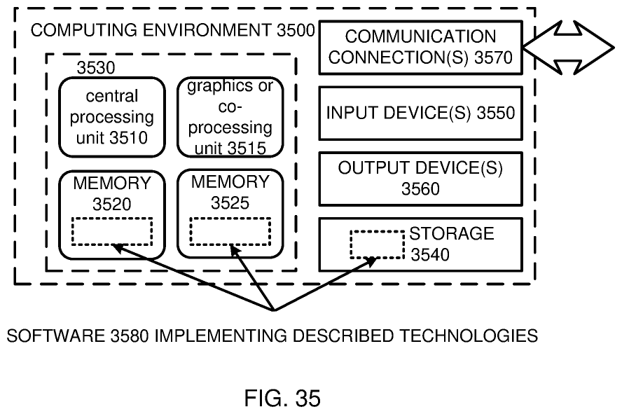

FIG. 35 depicts a generalized example of a suitable computing system 3500 in which the described innovations may be implemented. The computing system 3500 is not intended to suggest any limitation as to scope of use or functionality of the present disclosure, as the innovations may be implemented in diverse general-purpose or special-purpose computing systems.

With reference to FIG. 35, the computing system 3500 includes one or more processing units 3510, 3515 and memory 3520, 3525. In FIG. 35, this basic configuration 3530 is included within a dashed line. The processing units 3510, 3515 execute computer-executable instructions, such as for implementing a database environment, and associated methods, described in Examples 1-11. A processing unit can be a general-purpose central processing unit (CPU), a processor in an application-specific integrated circuit (ASIC), or any other type of processor. In a multi-processing system, multiple processing units execute computer-executable instructions to increase processing power. For example, FIG. 35 shows a central processing unit 3510 as well as a graphics processing unit or co-processing unit 3515. The tangible memory 3520, 3525 may be volatile memory (e.g., registers, cache, RAM), non-volatile memory (e.g., ROM, EEPROM, flash memory, etc.), or some combination of the two, accessible by the processing unit(s) 3510, 3515. The memory 3520, 3525 stores software 3580 implementing one or more innovations described herein, in the form of computer-executable instructions suitable for execution by the processing unit(s) 3510, 3515.

A computing system 3500 may have additional features. For example, the computing system 3500 includes storage 3540, one or more input devices 3550, one or more output devices 3560, and one or more communication connections 3570. An interconnection mechanism (not shown) such as a bus, controller, or network interconnects the components of the computing system 3500. Typically, operating system software (not shown) provides an operating environment for other software executing in the computing system 3500, and coordinates activities of the components of the computing system 3500.

The tangible storage 3540 may be removable or non-removable, and includes magnetic disks, magnetic tapes or cassettes, CD-ROMs, DVDs, or any other medium which can be used to store information in a non-transitory way, and which can be accessed within the computing system 3500. The storage 3540 stores instructions for the software 3580 implementing one or more innovations described herein.

The input device(s) 3550 may be a touch input device such as a keyboard, mouse, pen, or trackball, a voice input device, a scanning device, or another device that provides input to the computing system 3500. The output device(s) 3560 may be a display, printer, speaker, CD-writer, or another device that provides output from the computing system 3500.

The communication connection(s) 3570 enable communication over a communication medium to another computing entity, such as another database server. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

The innovations can be described in the general context of computer-executable instructions, such as those included in program modules, being executed in a computing system on a target real or virtual processor. Generally, program modules or components include routines, programs, libraries, objects, classes, components, data structures, etc. that perform particular tasks or implement particular abstract data types. The functionality of the program modules may be combined or split between program modules as desired in various embodiments. Computer-executable instructions for program modules may be executed within a local or distributed computing system.

The terms “system” and “device” are used interchangeably herein. Unless the context clearly indicates otherwise, neither term implies any limitation on a type of computing system or computing device. In general, a computing system or computing device can be local or distributed, and can include any combination of special-purpose hardware and/or general-purpose hardware with software implementing the functionality described herein.

For the sake of presentation, the detailed description uses terms like “determine” and “use” to describe computer operations in a computing system. These terms are high-level abstractions for operations performed by a computer, and should not be confused with acts performed by a human being. The actual computer operations corresponding to these terms vary depending on implementation.

### Example 13—Cloud Computing Environment

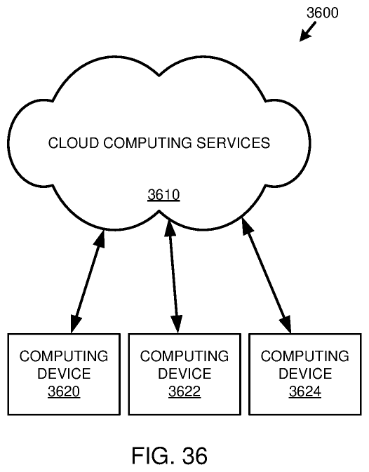

FIG. 36 depicts an example cloud computing environment 3600 in which the described technologies can be implemented. The cloud computing environment 3600 comprises cloud computing services 3610. The cloud computing services 3610 can comprise various types of cloud computing resources, such as computer servers, data storage repositories, networking resources, etc. The cloud computing services 3610 can be centrally located (e.g., provided by a data center of a business or organization) or distributed (e.g., provided by various computing resources located at different locations, such as different data centers and/or located in different cities or countries).

The cloud computing services 3610 are utilized by various types of computing devices (e.g., client computing devices), such as computing devices 3620, 3622, and 3624. For example, the computing devices (e.g., 3620, 3622, and 3624) can be computers (e.g., desktop or laptop computers), mobile devices (e.g., tablet computers or smart phones), or other types of computing devices. For example, the computing devices (e.g., 3620, 3622, and 3624) can utilize the cloud computing services 3610 to perform computing operators (e.g., data processing, data storage, and the like).

### Example 14—Implementations

Although the operations of some of the disclosed methods are described in a particular, sequential order for convenient presentation, it should be understood that this manner of description encompasses rearrangement, unless a particular ordering is required by specific language set forth herein. For example, operations described sequentially may in some cases be rearranged or performed concurrently. Moreover, for the sake of simplicity, the attached figures may not show the various ways in which the disclosed methods can be used in conjunction with other methods.

Any of the disclosed methods can be implemented as computer-executable instructions or a computer program product stored on one or more computer-readable storage media, such as tangible, non-transitory computer-readable storage media, and executed on a computing device (e.g., any available computing device, including smart phones or other mobile devices that include computing hardware). Tangible computer-readable storage media are any available tangible media that can be accessed within a computing environment (e.g., one or more optical media discs such as DVD or CD, volatile memory components (such as DRAM or SRAM), or nonvolatile memory components (such as flash memory or hard drives)). By way of example and with reference to FIG. 35, computer-readable storage media include memory 3520 and 3525, and storage 3540. The term computer-readable storage media does not include signals and carrier waves. In addition, the term computer-readable storage media does not include communication connections (e.g., 3570).

Any of the computer-executable instructions for implementing the disclosed techniques, as well as any data created and used during implementation of the disclosed embodiments, can be stored on one or more computer-readable storage media. The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, the disclosed technology can be implemented by software written in C++, Java, Perl, JavaScript, Python, Ruby, ABAP, Structured Query Language, Adobe Flash, or any other suitable programming language, or, in some examples, markup languages such as html or XML, or combinations of suitable programming languages and markup languages. Likewise, the disclosed technology is not limited to any particular computer or type of hardware. Certain details of suitable computers and hardware are well known and need not be set forth in detail in this disclosure.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

The disclosed methods, apparatus, and systems should not be construed as limiting in any way. Instead, the present disclosure is directed toward all novel and nonobvious features and aspects of the various disclosed embodiments, alone and in various combinations and sub combinations with one another. The disclosed methods, apparatus, and systems are not limited to any specific aspect or feature or combination thereof, nor do the disclosed embodiments require that any one or more specific advantages be present, or problems be solved.

The technologies from any example can be combined with the technologies described in any one or more of the other examples. In view of the many possible embodiments to which the principles of the disclosed technology may be applied, it should be recognized that the illustrated embodiments are examples of the disclosed technology and should not be taken as a limitation on the scope of the disclosed technology. Rather, the scope of the disclosed technology includes what is covered by the scope and spirit of the following claims.

What is claimed is:

1. A computing system comprising:
at least one memory;
one or more hardware processor units coupled to the at least one memory; and
one or more computer readable storage media storing computer-executable instructions that, when executed, cause the computing system to perform operations comprising:
receiving a set of a plurality of interpreter instructions;
for respective interpreter instructions of the set of the plurality of interpreter instructions, determining whether an operation is defined to replace the respective interpreter instruction with assembly code, wherein operations are defined for less than all types of interpreter instructions;
for respective interpreter instructions where an operation is defined, including the assembly code for the respective interpreter instruction in a consolidated interpreter instruction; and
executing the consolidated interpreter instruction, wherein the consolidated interpreter instruction replaces multiple interpreter instructions of the set of the plurality of interpreter instructions with corresponding assembly code.

2. The computing system of claim 1, the operations further comprising:
for at least one interpreter instruction of the set of the plurality of interpreter instructions, determining that an operation is not defined to replace the at least one interpreter instruction with assembly code;
replacing a virtual function call for the at least one interpreter instruction with a devirtualized function call; and
including the devirtualized function call in the consolidated interpreter instruction.

3. The computing system of claim 2, wherein replacing a virtual function call for the at least one respective interpreter instruction comprises performing a lookup to a virtual function table defined for the at least one respective interpreter instruction.

4. The computing system of claim 1, wherein executing the consolidated interpreter instruction is performed in a single iteration of an interpreter execution loop.

5. The computing system of claim 1, wherein the respective interpreter instructions are represented as instances of an abstract datatype representing interpreter instructions.

6. The computing system of claim 5, wherein respective instances of the abstract datatype are derived classes of a base abstract datatype representing interpreter instructions and overload an execute function of the base abstract datatype.

7. The computing system of claim 1, wherein the set of the plurality of instructions are distributed among multiple code units, and the consolidated interpreter instruction comprises all interpreter instructions for a code unit of the multiple code units.

8. The computing system of claim 7, wherein the consolidated interpreter instructions for the multiple code units are comprised within a set of interpreter instructions.

9. The computing system of claim 8, wherein the set of interpreter instructions comprises control structures for jumps between code units of the multiple code units and the control structures are not comprised within the consolidated interpreter instructions of the multiple code units.

10. The computing system of claim 1, wherein the including the assembly code for a respective interpreter is performed by a code generator and the executing the consolidated interpreter instructions is performed by an interpreter and the code generator and the interpreter share a common address space.

11. The computing system of claim 1, wherein the consolidated interpreter instruction comprises assembly code for at least two respective interpreter instructions and the assembly code comprises register allocation instructions.

12. The computing system of claim 11, wherein at least one register referenced by a register allocation instruction is mapped to a CPU register.

13. The computing system of claim 11, wherein a first register allocation instruction loads a value for an operand into a register and a result of an operation using the operand is written back to the register.

14. The computing system of claim 1, wherein the consolidated interpreter instruction comprises register allocation instructions.

15. The computing system of claim 14, wherein a register allocation instruction of the register allocation instructions allocates a devirtualized function call to a register.

16. The computing system of claim of claim 1, wherein operations within the consolidated interpreter instruction are sequential.

17. The computing system of claim 1, wherein the including the assembly code for a respective interpreter instruction in a consolidated interpreter instruction comprises dynamically requesting memory for the consolidated interpreter instruction.

18. The computing system of claim 17, wherein the dynamically requesting memory for the consolidated interpreter instruction comprises:
writing operations in the consolidated interpreter instruction;
determining a size of the operations;
requesting memory of the size to provide allocated memory; and
writing the consolidated interpreter instruction to the allocated memory.

19. A method, implemented in a computing system comprising at least one hardware processor and at least one memory coupled to the at least one hardware processor, the method comprising:
receiving a set of a plurality of interpreter instructions;
for respective interpreter instructions of the set of the plurality of interpreter instructions, determining whether an operation is defined to replace the respective interpreter instruction with assembly code, wherein operations are defined for less than all types of interpreter instructions;
for respective interpreter instructions where an operation is defined, including the assembly code for the respective interpreter instruction in a consolidated interpreter instruction; and
executing the consolidated interpreter instruction, wherein the consolidated interpreter instruction replaces multiple interpreter instructions of the set of the plurality of interpreter instructions with corresponding assembly code.

20. One or more non-transitory computer-readable storage media comprising:
computer-executable instructions that, when executed by a computing system comprising at least one hardware processor and at least one memory coupled to the at least one hardware processor, cause the computing system to receive a set of a plurality of interpreter instructions;
computer-executable instructions that, when executed by the computing system, cause the computing system to, for respective interpreter instructions of the set of the plurality of interpreter instructions, determine whether an operation is defined to replace the respective interpreter instruction with assembly code, wherein operations are defined for less than all types of interpreter instructions;
computer-executable instructions that, when executed by the computing system, cause the computing system to, for respective interpreter instructions where an operation is defined, include the assembly code for the respective interpreter instruction in a consolidated interpreter instruction; and
computer-executable instructions that, when executed by the computing system, cause the computing system to execute the consolidated interpreter instruction, wherein the consolidated interpreter instruction replaces multiple interpreter instructions of the set of the plurality of interpreter instructions with corresponding assembly code.
